(19) United States
(12) Patent Application Publication
(10) Pub. No.: US 2025/0276490 A1
(43) Pub. Date: Sep. 4, 2025

(54) SYSTEM AND METHOD FOR THREE-DIMENSIONALLY PRINTING TRANSPARENT PARTS

(71) Applicant: SprintRay, Inc., Los Angeles, CA (US)

(72) Inventors: Eric Leal, Los Angeles, CA (US); Haybert Yousefi, Los Angeles, CA (US)

(21) Appl. No.: 19/211,053

(22) Filed: May 16, 2025

Related U.S. Application Data
(63) Continuation-in-part of application No. 18/642,156, filed on Apr. 22, 2024.
Application No. 18/642,156 is a continuation of application No. 18/211,525, filed on Jun. 19, 2023.
Application No. 18/211,525 is a continuation of application No. 17/151,540, filed on Jan. 18, 2021, now Pat. No. 11,679,555.
Application No. 17/151,540 is a continuation-in-part of application No. 16/944,878, filed on Jul. 31, 2020, now Pat. No. 11,548,224.
Application No. 16/944,878 is a continuation of application No. 16/556,118, filed on Aug. 29, 2019, now Pat. No. 10,766,194.
(60) Provisional application No. 62/808,295, filed on Feb. 21, 2019.

(51) Int. Cl. B29C 64/255; B29C 64/129; B29C 64/245; B29C 64/264; B33Y 30/00

(52) U.S. Cl. CPC B29C 64/255; B29C 64/245; B29C 64/264; B29C 64/129; B33Y 30/00

(57) ABSTRACT

A system and method of producing transparent dental appliances. The system includes a reservoir tank assembly with a reconfigurable multi-layer light diffusing assembly. The light diffusing assembly diffuses the curing light thereby reducing defects within the printed part. The light diffusing assembly is easily reconfigurable to provide various levels of light diffusion. The system and method also includes a method for reorienting the build model to a specific offset angle for the three-dimensional printing process to improve the printed part's overall transparency.

### PRIORITY AND RELATED APPLICATIONS

This application is a Non-Provisional Application of Provisional Application No. 63/566,845 and a continuation-in-part of U.S. Non-Provisional application Ser. No. 18/642,156, which is a continuation of U.S. Non-Provisional application Ser. No. 18/211,525, filed on Jun. 19, 2023, which is a continuation of U.S. Non-Provisional application Ser. No. 17/151,540, filed on Sep. 2, 2022, which is a continuation-in-part of U.S. Non-Provisional application Ser. No. 16/944,878, filed on Jul. 31, 2020, which is a continuation of U.S. Non-Provisional application Ser. No. 16/556,118, filed on Aug. 29, 2019, which claims the benefit of Provisional Application No. 62/808,295, filed Feb. 21, 2019, all of which are incorporated herein by reference in their entirety.

### TECHNICAL FIELD OF THE INVENTION

This present invention relates to additive manufacturing systems, including

an additive manufacturing system and method to three-dimensionally print transparent objects.

### BACKGROUND OF THE INVENTION

Transparent dental appliances, such as retainers, aligners, and night guards, are typically fabricated using three-dimensional (3D) printing systems with photosensitive resin that cures transparent.

However, current such 3D printing systems oftentimes cause defects to occur within the cured resin that adversely affect the 3D printed part's transparency. For example, surface defects within the cured part may cause light incident upon the outer surface of the dental appliance to scatter thereby giving the appliance a matte appearance.

Current 3D printing systems have attempted to minimize these defects by providing a light diffusing element between the light source and the layer of resin to be cured to provide diffused curing light. However, these systems are limited in their ability to adequately diffuse the light and to adequately eliminate the defects. Such systems also are not easily reconfigurable to modify the amount of light diffusion applied.

Accordingly, there is a need for a 3D printing system and method that provides a multi-layered and reconfigurable light diffusion assembly. There also is a need for a resin tank assembly for use with a 3D printing system that secures and enables reconfiguration of the said multi-layered and reconfigurable light diffusion assembly. There also is a need for a printing system that eliminates surface imperfections typically found in conventional LCD-based three-dimension (3D) printing systems.

### SUMMARY OF THE INVENTION

According to one aspect, one or more embodiments are provided below for

a system and method of producing dental appliances with improved surface quality and transparency characteristics using additive manufacturing.

In some exemplary embodiments, an additive manufacturing system in accordance with the present invention is comprised of: a resin tank assembly; a build surface; a light emitting system; and an optical diffusion structure comprising: a separation film assembly; a display assembly including a display panel and a filter; and a rigid substrate; wherein a light emitted from the light emitting system is adapted to pass through the optical diffusion structure to cure a layer of resin of a 3D-printed object. In some exemplary embodiments, the separation film assembly includes a separation film, a separation film upper surface, and a separation film lower surface. In some exemplary embodiments, the display assembly further includes a light diffusing film, a diffusing film upper surface, and a diffusing film lower surface. In some exemplary embodiments, the light diffusing structure further comprises a first interface formed at a first mating of the separation film lower surface and the diffusing film upper surface, and a second interface formed at a second mating of the diffusing film lower surface and the rigid substrate upper surface; wherein light emitted from the light emitting system passes through the rigid substrate and the second interface and through the light diffusing film and the first interface and through the separation film to cure a layer of resin at the print surface; and wherein the light is diffused by passing through the first interface and through the second interface.

In some exemplary embodiments, an additive manufacturing system is comprised of a resin tank reservoir, a build surface, and an optical assembly system, wherein the optical assembly system includes a display assembly and a support structure. In some exemplary embodiments, the build surface is disposed within a reservoir. In some exemplary embodiments, the display assembly includes a light source. In some exemplary embodiments, the additive manufacturing system is further comprised of a light emitting system.

In some exemplary embodiments, an additive manufacturing system is comprised of a resin tank assembly, a build surface, a light emitting system, and an optical diffusion structure, wherein a light emitted from the light emitting system is adapted to pass through the optical assembly system. In some exemplary embodiments, the optical diffusion structure is a multi-layer structure comprised of a separation film including a separation film including a separation film upper surface and a separation film lower surface; a light diffusing film including a diffusing film upper surface and a diffusing film lower surface; a rigid substrate including a rigid substrate upper surface and a rigid substrate lower surface; a first interface formed at a first mating of the separation film lower surface and the diffusing film upper surface, and a second interface formed at a second mating of the diffusing film lower surface and the rigid substrate upper surface; wherein light emitted from the light emitting system passes through the rigid substrate and the second interface and through the light diffusing film and the first interface and through the separation film to cure a layer of resin at the print surface; and wherein the light is diffused by passing through the first interface and through the second interface.

In some exemplary embodiments, an additive manufacturing system in accordance with the present invention is comprised of: a reservoir for housing a photosensitive resin; a build surface disposed within the reservoir; a light emitting system; and a light-diffusing element comprising: a separation film including a separation film upper surface and a separation film lower surface; a display assembly including a display panel and a diffusing film; and a rigid substrate including a rigid substrate upper surface and a rigid substrate lower surface; wherein a light emitted from the light emitting system is adapted to pass through the light-diffusing element structure to cure a layer of resin of a 3D-printed object. In some exemplary embodiments, the diffusing film includes a diffusing upper surface and a diffusing film lower surface. In some exemplary embodiments, the optical diffusion structure further includes a first interface formed at a first mating of the separation film lower surface and the diffusing film upper surface, and a second interface formed at a second mating of the diffusing film lower surface and the rigid substrate upper surface; wherein light emitted from the light emitting system passes through the rigid substrate and the second interface and through the diffusing film and the first interface and through the separation film to cure a layer of resin at a print surface; and wherein the light is diffused by passing through the first interface and through the second interface. In some exemplary embodiments, the light diffusing element is a multi-layer light-diffusing element including multiple diffusing elements.

In some exemplary embodiments, the diffusing film is a polyethylene terephthalate (PET) film with a thickness of 0.1 mm, a haze of 94.7%-95.9%, and a light transmittance of 92%-96%. In some exemplary embodiments, the diffusing film has a single-sided matte finished surface.

In some exemplary embodiments the separation film upper surface includes a matte surface finish, and the separation film lower surface includes a glossy surface finish; the diffusing film upper surface includes a glossy surface finish, and the diffusing film lower surface includes a matte surface finish; and the rigid substrate upper surface includes an etched surface finish.

In other exemplary embodiments, the separation film upper surface includes a matte surface finish, and the separation film lower surface includes a glossy surface finish; the diffusing film upper surface includes a matte surface finish, and the diffusing film lower surface includes a glossy surface finish; and the rigid substrate upper surface includes an etched surface finish.

In yet another exemplary embodiment, the separation film upper surface includes a matte surface finish, and the separation film lower surface includes a glossy surface finish; the diffusing film upper surface includes a glossy surface finish, and the diffusing film lower surface includes a matte surface finish; and the rigid substrate upper surface includes a glossy surface finish

In yet another exemplary embodiment, the separation film upper surface includes a matte surface finish, and the separation film lower surface includes a glossy surface finish; the diffusing film upper surface includes a matte surface finish, and the diffusing film lower surface includes a glossy surface finish; and the rigid substrate upper surface includes a glossy surface finish.

In some exemplary embodiment, the separation film comprises a transparent Polymethylpentene (PMP) film, and the separation film upper surface includes a glossy surface finish, and the separation film lower surface includes a matte surface finish; the diffusing film comprises tempered glass, and the diffusing film upper surface includes a glossy surface finish, and the diffusing film lower surface includes a glossy surface finish; and the rigid substrate upper surface includes an etched surface finish.

In some exemplary embodiments, an exemplary additive manufacturing system further comprises a reservoir base assembly configured to support the reservoir, the separation film, the light diffusing film, and the rigid substrate, the reservoir base assembly comprising: an aperture through which the light passes; a first ledge configured to receive and support a first peripheral portion of the rigid substrate; and a second ledge configured to receive and support a second peripheral portion of the separation film.

In some exemplary embodiments, the second ledge is outside a first perimeter established by the first ledge. In some exemplary embodiments, the second peripheral portion of the separation film is secured within a peripheral bracket. In some exemplary embodiments, at least a portion of the peripheral bracket is received and supported by the second ledge.

In some exemplary embodiments, a method of using a three-dimensional (3D) printing system to form a transparent object may be comprised of: receiving a digital model of the object, the digital model including at least one side surface; offsetting a first at least one side surface to a first offset angle away from a vertical orientation to form a first offset side surface in the digital model; determining a first side surface profile of the first offset side surface, wherein the first side surface profile includes a series of sequential transition steps with each transition step within the series of sequential transition steps including a vertical step size and a horizontal step size; determining a single light pixel width used by the 3D printing system; determining a proportion of the horizontal step size to the single light pixel width; determining whether the proportion is within a proportion range; in response to a determination that the proportion is within the proportion range, then: 3D printing the first side surface with the digital model at the first offset angle; wherein the proportion range is one eighth to seven eighths.

In some exemplary embodiments, the proportion range is one quarter to three quarters. In other exemplary embodiments, the proportion range is three eighths to five eighths. In yet another exemplary embodiment, the proportion range is three eighths to one half.

In some exemplary embodiments, the first offset angle is about 1° to about 40°. In another exemplary embodiment, the first offset angle is about 1° to about 30°. In yet another exemplary embodiment, the first offset angle is about 1° to about 20°. In some exemplary embodiments, the method of claim 11 wherein the first offset angle is about 5° to about 15°. In some exemplary embodiments, the first offset angle is about 10°.

In some exemplary embodiments, a method for using a 3D printing system to form a transparent object may further comprise of: prior to offsetting the first at least one side surface to the first offset angle away from a vertical orientation to form the first offset side surface in the model, orienting the first side surface of the digital model to the vertical orientation.

In some exemplary embodiments, an optical assembly system for an LCD-based 3D printer may be comprised of a display assembly, a structural frame, and a connection PCB. In some exemplary embodiments, the display assembly includes a display panel, a filter or a light-diffusing medium, and a lens. In some exemplary embodiments, the display assembly further includes a protective glass, a structural glass, and a securing mechanism. In some exemplary embodiments, the display assembly further includes a light source or light emitting system. In some exemplary embodiments, the display panel is an LCD panel. In some exemplary embodiments, the light-diffusing medium is a diffusion film or a light-diffusing film. In some exemplary embodiments, the lens is a Fresnel lens. In some exemplary embodiments, the filter is situated below the LCD panel.

In some exemplary embodiments, the light-diffusing film is a PET film. In some exemplary embodiments, the PET film has a thickness of 0.1 mm. In some exemplary embodiments, the PET film has a haze of 94.7%-95.9%. In some exemplary embodiments, the lower surface of the light-diffusing film includes a matte surface finish. In some exemplary embodiments, the light-diffusing film has a single-sided matte finished surface. In some exemplary embodiments, the PET film has a light transmittance of 92%-96%.

In some exemplary embodiments, a resin tank system may include a resin tank body, a resin tank base assembly, a separation film assembly, a light diffusing element, and a rigid substrate. In some exemplary embodiments, the resin tank system is adapted to house a photosensitive resin. In some exemplary embodiments, the building platform may be at least partially submerged within the resin. In some exemplary embodiments, the light provided by the light emitting system may be adapted to cure the resin layer-by-layer onto the build platform's build surface. The resin tank system also may include additional elements as necessary for the system to perform its functionalities. In some exemplary embodiments a first light is emitting from the light emitting system is adapted to pass through the rigid substrate, the light diffusing element, and the separation film in sequence and is further adapted to emerge as a second light. In some exemplary embodiments, the second light is thereafter adapted to cure a lawyer of uncured resin situated directly above the separation film assembly. In some exemplary embodiments, the combination of surface properties of the rigid substrate, light diffusing element, and the separation film assembly is adapted to facilitate the transformation of the first light to the second light.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 illustrates a 3D printing system in accordance with exemplary embodiments hereof;

FIGS. 2A-2B illustrates aspects of light diffusing structure in accordance with exemplary embodiments hereof;

FIG. 3 illustrates aspects of a light diffusing structure in accordance with exemplary embodiments hereof;

FIG. 4 illustrates a table of specifications in accordance with exemplary embodiments hereof;

FIGS. 5-8B illustrate aspects of a resin tank assembly in accordance with exemplary embodiments hereof;

FIG. 9 illustrates 3D printed dental appliances in accordance with exemplary embodiments hereof;

FIG. 10 illustrates a 3D printing system in accordance with exemplary embodiments hereof;

FIG. 11 illustrates an object's digital model and corresponding cured layers of resin in accordance with exemplary embodiments hereof;

FIG. 12 illustrates sequential cured layers of resin in accordance with exemplary embodiments hereof;

FIG. 13 illustrates cured layers of resin in accordance with exemplary embodiments hereof;

FIG. 14 illustrates an object's digital model and corresponding cured layers of resin in accordance with exemplary embodiments hereof;

FIG. 15 illustrates sequential cured layers of resin in accordance with exemplary embodiments hereof;

FIG. 16 illustrates cured layers of resin in accordance with exemplary embodiments hereof;

FIG. 17 illustrates an object's surfaces in accordance with exemplary embodiments hereof;

FIG. 18 illustrates a 3D printed dental appliance in accordance with exemplary embodiments hereof;

FIG. 19 illustrates a workflow in accordance with exemplary embodiments hereof;

FIGS. 20-23 illustrate surface profiles in accordance with exemplary embodiments hereof;

FIGS. 24-25 illustrate aspects of a printed dental appliance in accordance with exemplary embodiments hereof;

FIG. 26 illustrates a first build orientation of a dental appliance in accordance with exemplary embodiments hereof;

FIG. 27 illustrates a second build orientation of a dental appliance in accordance with exemplary embodiments hereof;

FIG. 28 illustrates a workflow in accordance with exemplary embodiments hereof;

FIG. 29 illustrates aspects of computing and computer devices in accordance with exemplary embodiments hereof.

FIGS. 30A-30E illustrate multiple perspective views of a 3D-printed part that has been printed with an exemplary optical polish assembly system.

FIGS. 31A-31E illustrate multiple perspective views of a 3D-printed part that has been printed with a regular LCD assembly.

FIGS. 32A-32B illustrate side-by-side comparisons of a 3D-printed part printed with a regular LCD assembly and a 3D-printed part receiving the benefit of the present invention.

FIG. 33 illustrates an exploded view of the display assembly in accordance with exemplary embodiments hereof; and

FIG. 34 illustrates an exploded view of an optical panel assembly in accordance with exemplary embodiments hereof.

### DETAILED DESCRIPTION OF THE INVENTION

In general, the system and method according to exemplary embodiments hereof includes a system and method of producing objects (e.g., dental appliances) with an improved surface quality and transparency appearance using additive manufacturing systems (e.g., three-dimensional (3D) printing systems). As a result, the need to manually polish the printed objects after the 3D printing process is completed may be minimized or eliminated.

This specification describes embodiments primarily pertaining to two discoveries for improving the surface transparency quality and appearance of 3D printed objects. The first discovery primarily pertains to the use of a light diffusing assembly for affecting the curing light provided by the 3D printing system to improve the object's transparency as a first aspect of the current invention. These embodiments will be referred to herein as light diffusion embodiments. The second discovery primarily pertains to a method of purposely reorienting an object's digital model away from the customary orientation by a predetermined amount during the 3D printing process to improve the object's transparency as a second aspect of the current invention. These embodiments will be referred to herein as model reorientation embodiments.

For the purposes of this specification, the light diffusion embodiments and the model reorientation embodiments will be described individually and independently of one another. In addition, it is understood that any of the light diffusion embodiments and/or any of the model reorientation embodiments may be implemented and utilized individually and/or in any combination whatsoever with one another. That is, any of the light diffusion embodiments may be utilized independently of any of the model reorientation embodiments and/or may be utilized in any combination with any of the model reorientation embodiments, and any of the model reorientation embodiments may be utilized independently of any of the light diffusion embodiments and/or may be utilized in any combination with any of the light diffusion embodiments.

In general, when a transparent part is 3D printed using photosensitive resin that cures transparent, defects within the 3D printed part formed during the printing process may adversely affect the part's resulting transparency characteristics. Furthermore, defects that reside at or close to a side surface of the final printed part (e.g., on the outer surface of a dental appliance such as a night guard) may have a significant negative impact on the part's overall transparency appearance.

For instance, surface defects on a transparent 3D printed part may tend to scatter light incident on the surface at the point of the defect. As such, if the part has repeating or continuous defects along its surface, the defects may cause the surface to appear to have a matte finish, and as such, less transparency.

Such defects may be caused by a variety of phenomena. For example, each pixel of light that cures each voxel of resin may have an intensity profile that is varies across the pixel. In some cases, the light intensity may be greater in the inner regions of the pixel and lesser in the pixel's outer regions. This may cause uneven curing across the voxel thereby causing the surface of the voxel to be uneven. The uneven intensity profile of the light pixel also may cause the boundaries between adjacent voxels to be sharp and more defined. These uneven surfaces and sharply defined boundaries between adjacent voxels may cause incident light to scatter thereby causing the part to appear more matte. The boundaries also may appear as visible lines in the printed part that further diminish the part's transparency.

In addition, when 3D printing transparent objects (such as dental appliances), because the resin material may be transparent (or near transparent), a portion of a light pixel used to cure a voxel of resin may pass through the immediate layer of resin and may irradiate, and overcure, a portion of the previously cured layer underneath. Furthermore, because the light pixel may have a higher intensity in the inner regions of the pixel, the underneath portion may be overcured unevenly, with more overcuring in the inner portions and less in the outer regions. This may cause the overcured portion to be uneven, e.g., it may protrude more in the inner areas and less in the outer or boundary areas. This uneven surface may result in a visible point defect in the cured material that may repeat from voxel to voxel, and layer to layer. As such, light incident on these defects may be caused to scatter thereby adversely affecting the printed object's overall transparency profile. Other types of defects caused by the 3D printing process also may diminish a part's transparency.

### Light Diffusion Embodiments

In some exemplary embodiments, the current invention provides a multi-layer optical diffusion structure to even out the light intensity profiles across the light pixels and to thereby provide a more evenly distributed and uniform light intensity to the layer of resin being cured. In this way, each voxel may be cured more evenly across the voxel profile resulting in a smoother voxel surface and softer (e.g., blurred) boundaries between adjacent voxels. This in turn may provide a higher transparency profile for the 3D printed object.

For the purposes of this specification, unless specifically stated otherwise, the following terms will mean:

Surface finish (also referred to as surface texture or surface topology) is the nature of the surface as defined by the lay of the surface, the surface roughness, and the surface waviness.

Glossy surface finish is a smooth and shiny surface. Light incident upon a glossy surface reflects from the surface in a specular direction (typically in a single direction). The reflected light beams are in phase resulting in constructive interference of the light beams. Light passing through the glossy surface (e.g., through glass with a glossy surface) passes through the glass without significant scattering and with minimal distortion. In this way, the intensity and direction of the light passing through the glossy surface remains relatively unchanged depending on the medium.

Matte surface finish is a dull surface with a low glossy percentage. Light incident upon a matte surface reflects much less compared to light incident upon a glossy surface. Light that is reflected from a matte surface and/or that transmits through a matte surface tends to be diffused and scattered. In addition, the intensity of the light passing through a matte surface may be reduced.

Etched surface finish (also referred to as frosted surface finish) is a matte surface comprising a roughened surface in the micrometer range. Light incident upon an etched surface results in a diffused reflection and transmission wherein the light is scattered in many different directions. The diffused light is out of phase resulting in destructive interference of the light beams. An ideal diffuse reflecting surface is said to exhibit Lambertian reflection, meaning that there is equal luminance when viewed from all directions lying in the half-space adjacent to the surface. Surfaces may be etched using acid (e.g., hexafluoro silicic acid (H₂SiF₆), by abrasion (e.g., sand blasting), and/or by other means.

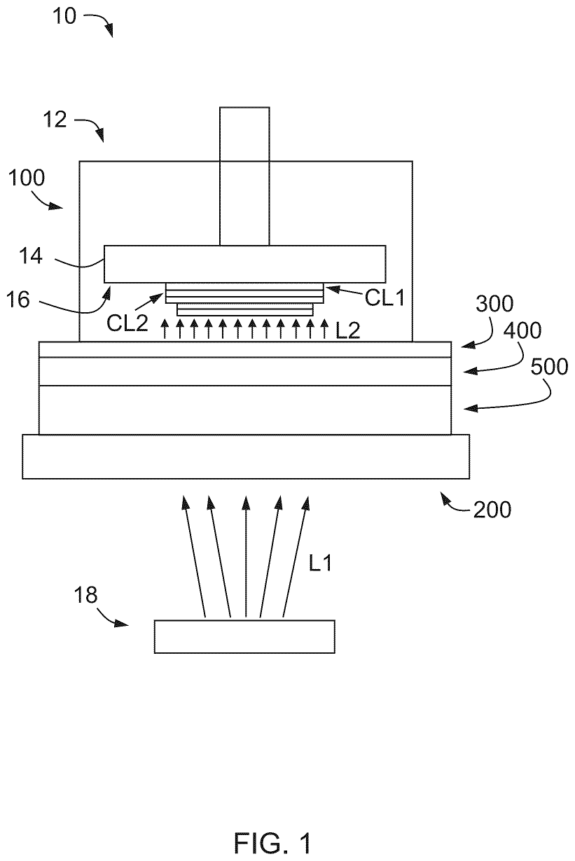

Turning now to the figures, FIG. 1 illustrates a block diagram of an exemplary three-dimensional (3D) printing system 10. In some exemplary embodiments, as illustrated in FIG. 1, an exemplary 3D printing system 10 may include a resin tank system 12, a build platform 14, and a light emitting system 18. In some exemplary embodiments, the build platform 14 may include an underneath build surface 16.

In some exemplary embodiments, as shown in FIG. 1, the resin tank system 12 (also referred to herein as simply the system 12) may include a resin tank body 100, a resin tank base assembly 200, a separation film assembly 300, a light diffusing element 400, and a rigid substrate 500. In general, a volume of photosensitive resin placed within the resin tank system 10, the building platform 14 may be submerged within the resin, and light provided by the light emitting system 18 cures the resin layer-by-layer (e.g., into cured layers CL1 and CL2) onto the build platform' build surface 16. The resin tank system 12 also may include additional elements as necessary for the system 10 to perform its functionalities.

In some embodiments, light L1 emitted from the light emitting system 18 passes through the rigid substrate 500, the light diffusing element 400, and the separation film assembly 300 in sequence and emerges as light L2. Light L2 is then projected to a layer of uncured resin directly above the separation film assembly 300 to cure the layer. As described herein, the rigid substrate 500, the light diffusing element 400, and the separation film assembly 300 each include specific surface properties, that when combined together in a particular arrangement, affect the light L1 to produce the light L2. The light L2 provides improved transparency characteristics to the printed part as described herein.

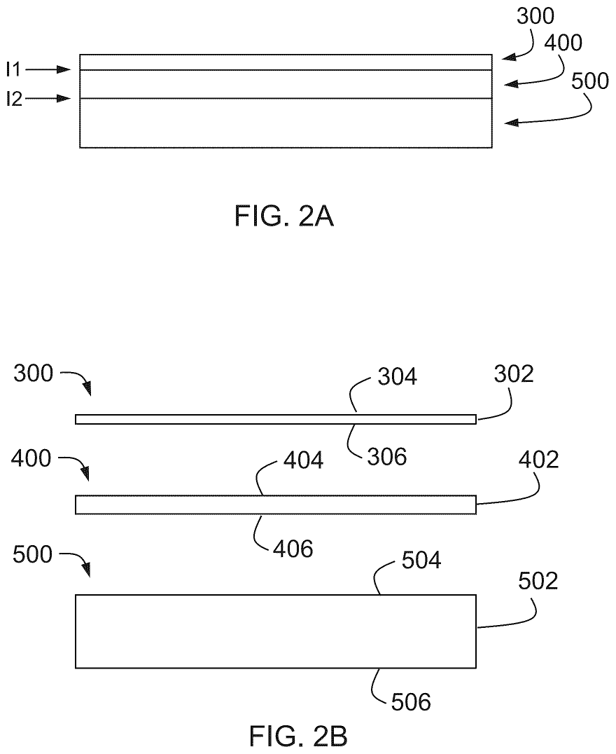

FIG. 2A illustrates a block diagram of an exemplary light diffusing structure in accordance with exemplary embodiments of the present invention. More specifically, FIG. 2A illustrates the separation film assembly 300, the light diffusing element 400, and the rigid substrate 500 combined, and FIG. 2B shows a block diagram of the elements 300, 400, 500 separated for clarity.

In some exemplary embodiments, as illustrated in FIG. 2B, the separation film assembly 300 includes a separation film 302 with an upper surface 304 and a lower surface 306, the light diffusing element 400 includes a light diffusing film 402 with an upper surface 404 and a lower surface 406, and the rigid substrate 500 includes a substrate body 502 with an upper surface 504 and a lower surface 506. In some exemplary embodiments, the rigid substrate 500 may be comprised of silicon dioxide. In some exemplary embodiments, the rigid substrate 500 may have a roughness of Ra 1.0.

In some exemplary embodiments, the separation film assembly 300 may include a transparent polymethylpentene (e.g., TPX film) or ACF film. In some exemplary embodiments, the light diffusion element 400 may be comprised of tempered glass.

In some exemplary embodiments, the separation film may be a TPX film. The TPX film provides heat resistant and superior releasability characteristics. Transparency: TPX film also exhibits excellent transparency (e.g., haze: <5%) and light transmittance. Although the TPX film is a crystalline polymer, it exhibits excellent transparency and light transmittance and has a higher UV transmittance in comparison to glass and other transparent polymer counterparts. Low refraction:

TPX film also has a low refractive index (e.g., 1.463nD20), lower than fluorine polymers. Gas permeability—Oxygen: TPX film also has characteristic of excellent gas permeability derived from its molecular structure, including but not limited to excellent oxygen permeability, so as to decrease the separation force between the 3D-printed object and the film of an exemplary separation film assembly 300. Chemical resistance: TPX film also shows excellent chemical resistance, particularly against acids, alkalis and alcohol. In the context of 3D-printing, the chemical resistance of TPX film is advantageous against isopropyl alcohol (IPA) and methacrylic acid. Heat resistance: TPX film has a high melting point (e.g., in the range of 220° C. to 240° C.) and a high vicat softening temperature.

In some exemplary embodiments, the TPX film has a thickness of 0.003 in (0.0762 mm), the elongation is lower than 25% (e.g., 10%), the tensile strength is preferably 4110 psi (pounds per square inch). In some exemplary embodiments, the upper surface is glossy and the lower surface is matte, and the glossiness of the TPX film may be over 70 Gu.

In some exemplary embodiments, the separation film assembly 300 may include an ACF film. The ACF film is a composite film including an upper separation layer and a lower buffer layer. In some exemplary embodiments, the upper surface of the separation layer includes a glossy surface finish and the lower surface of a buffer layer includes a matte surface finish. The ACF film may reach a light transmittance of approximately 90% under light conditions. In some exemplary embodiments, the transmittance ratio of the ACF film may be 95%. ACF film also demonstrates excellent heat resistance characteristics. The ACF film has a high melting point over 300° C. In some exemplary embodiments, the thickness of the ACF film is approximately 0.3 mm.

In some exemplary embodiments, the separation film assembly 300 may include another composite film arrangement. In this arrangement, the light diffusing film 402 may be incorporated into a composite film with the separation film 302.

In some exemplary embodiments, the separation film assembly 300 may include film comprised of other transparent plastic material with excellent transparency characteristics.

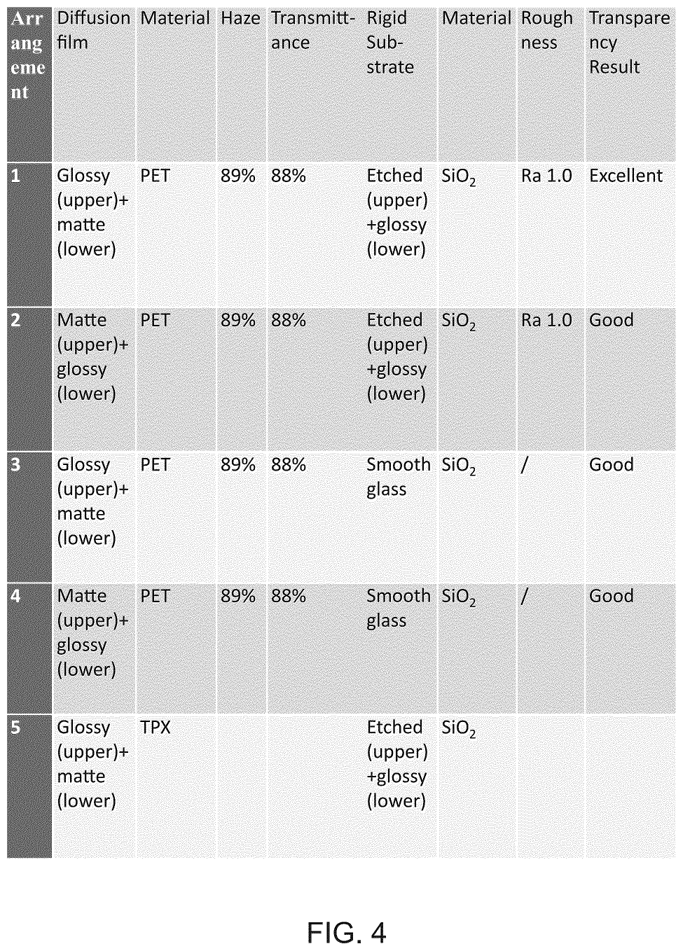

In some exemplary embodiments, the light diffusing element 400 is a PET film. As illustrated in FIG. 4, in some exemplary embodiments, the PET film may have a glossy surface and, on the opposite, may have a matte surface. In some exemplary embodiments, the PET film may have a haze of 89% and a transmittance of 88%.

Notably, in exemplary embodiments, any of the separation film assembly 300, the light diffusing element 400, and the rigid substrate 500 may include light diffusing properties. For example, any of the surfaces 304, 306, 404, 406, 504, 506 of the separation film assembly 300, the light diffusing element 400, and the rigid substrate 500, respectively, may include light diffusing properties as described in other sections. As such, first versions of any of the parts 300, 400, 500 including first light diffusing properties may be interchangeable with second versions of any of the parts 300, 400, 500 including second light diffusing properties. In this way, the system 10 provides a uniquely reconfigurable and interchangeable assembly of parts 300, 400, 500 that may be arranged in various different arrangements to modify the amount of light diffusion imposed by the system as required by the specifications of the 3D printed part, by the type of resin being used, and by other factors as described herein.

Given the above, in some exemplary embodiments, the separation film assembly 300, the light diffusing element 400, and the rigid substrate 500 in any combination may be referred to as a light diffusing assembly.

In some embodiments, as shown in FIGS. 2A and 2B, a first interface I1 may be defined at the abutment of the separation film's lower surface 306 and the light diffusing film's upper surface 404, and a second interface I2 may be defined at the abutment of the light diffusing film's lower surface 406 and the substrate body's upper surface 504. As described herein, the surface properties of these various surfaces are specifically chosen to transform the light L1 into the light L2. Specifically, the surface properties of the separation film's lower surface 306 and the surface properties of the light diffusing film's upper surface 404 are chosen such that when the surfaces 306 and 404 are mated to form the first interface I1, the first interface I1 includes specific light affecting properties. In addition, the surface properties of the light diffusing film's lower surface 406 and the surface properties of the rigid substrate's upper surface 504 are chosen such that when the surfaces 406 and 504 are mated to form the second interface I2, the second interface I2 includes specific light affecting properties.

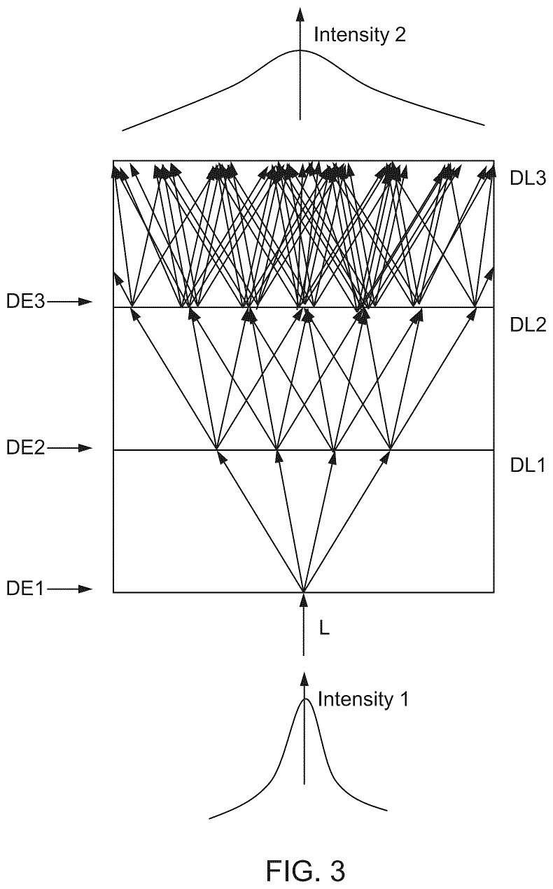

For the purposes of discussion, FIG. 3 illustrates a block diagram that represents a generalized multi-layer optical diffusion structure comprising three sequential light diffusing elements DE1, DE2, and DE3. FIG. 3 also illustrates the various stages of diffusion that a light pixel may experience as it passes upward through the structure. For example, and in no way limiting the scope of the present invention, a pixel of light L incident on a first light diffusion element DE1 may be scattered into a multitude of light beams as first diffused light DL1. Each light beam of the first diffused light DL1 that passes through the second light diffusing element DE2 also may be scattered into multiple light beams as second diffused light DL2, and each light beam of the second diffused light DL2 that passes through the third light diffusing element DE3 may be scattered into multiple light beams as third diffused light DL3. As seen, a sharp intensity profile (Intensity 1) of a single pixel of light L may be transformed into a more evenly distributed intensity profile of diffused light (Intensity 2) by passing through each sequential layer DE1, DE2, DE3 of the optical diffusion structure.

It is understood that FIG. 3 is presented for demonstration and that it may be preferable that the diffused light (e.g., third diffused light DL3) may fit and/or be contained within the desired pixel profile upon being incident to the photosensitive resin such that only the preferred voxel of resin may be properly irradiated and cured.

In some embodiments, the rigid substrate 500, the light diffusing element 400, and the separation film assembly 300 of the current invention are configured in specific arrangements to provide such first, second and third diffused light DL1, DL2, DL3.

### Light Diffusing Arrangement 1

In some exemplary embodiments, the separation film's upper surface 304 includes a matte finish and its lower surface 306 includes a glossy finish. The light diffusing film's upper surface 404 has a glossy surface finish and its lower surface 406 is a matte surface finish. In addition, the substrate body's upper surface 504 has an etched surface finish and its lower surface 506 has a glossy surface finish. Given this, the first interface I1 is an interface of the separation film's lower surface 306 and light diffusing film's upper glossy surface 404, and the second interface I2 is an interface of the light diffusing film's lower matte surface 406 and the substrate body's upper etched surface 504.

In this arrangement, the first light L1 first passes through the substrate body's glossy lower surface 506 and remains relatively unaffected. The light then passes through the second interface I2 comprising the substrate body's etched upper surface 504 and the light diffusing film's matte lower surface 406. At this interface I2, the light is first diffused as it passes through the substrate body's upper etched surface 504 and then this first diffused light is further diffused into second diffused light as it passes through the light diffusing film's lower matte surface 406. The second diffused light then transmits through the light diffusing film 402 and through the first interface I1 comprising the light diffusing film's upper glossy surface 404 and the separation film's glossy lower surface 306. This first interface I1, being glossy, passes the second diffused light through without significant distortion. However, as the second diffused light passes through the matte upper surface 304 of the separation film 302, the second diffused light is further diffused into third diffused light. The third diffused light then provides an even distribution of light to the layer of resin above the separation film assembly 300 within the resin reservoir 100 to cure the layer.

### Light Diffusing Arrangement 2

In some embodiments, the separation film's upper surface 304 includes a matte finish and its lower surface 306 includes a glossy finish. The light diffusing film's upper surface 404 has a matte surface finish and its lower surface 406 is a glossy surface finish. In addition, the substrate body's upper surface 504 has an etched surface finish and its lower surface 506 has a glossy surface finish. Given this, the first interface I1 is an interface of the separation film's lower surface 306 and light diffusing film's upper matte surface 404, and the second interface I2 is an interface of the light diffusing film's lower glossy surface 406 and the substrate body's upper etched surface 504.

In this arrangement, the first light L1 first passes through the substrate body's glossy lower surface 506 and remains relatively unaffected. The light then passes through the second interface I2 comprising the substrate body's etched upper surface 504 and the light diffusing film's glossy lower surface 406. This second interface I2 diffuses the light into first diffused light due to the substrate body's etched upper surface 504. The first diffused light transmits through the light diffusing film 402 and through the first interface I1 comprising the light diffusing film's matte upper surface 404 and the separation film's glossy lower surface 306. This first interface I1, being matte (due to the light diffusing film's matte upper surface 404), diffuses the first diffused light further into second diffused light. The second diffused light passes through the separation film 302 and through the film's matte upper surface 304 and is further diffused into third diffused light. The third diffused light then provides an even distribution of light to the layer of resin above the separation film assembly 300 within the resin reservoir 100 to cure the layer.

### Light Diffusing Arrangement 3

In some embodiments, the separation film's upper surface 304 includes a matte finish and its lower surface 306 includes a glossy finish. The light diffusing film's upper surface 404 has a glossy surface finish and its lower surface 406 is a matte surface finish. In addition, the substrate body's upper surface 504 and lower surface 506 each have a glossy surface finish. Given this, the first interface I1 is an interface of the separation film's lower surface 306 and light diffusing film's glossy upper surface 404, and the second interface I2 is an interface of the light diffusing film's matte lower surface 406 and the substrate body's glossy upper surface 504.

In this arrangement, the first light L1 first passes through the substrate body's glossy lower surface 506 and remains relatively unaffected. The light then passes through the second interface I2 comprising the substrate body's glossy upper surface 504 and the light diffusing film's matte lower surface 406. This second interface I2 diffuses the light into first diffused light due to the diffusing film's matte lower surface 406. The first diffused light transmits through the light diffusing film 402 and through the first interface I1 comprising the light diffusing film's glossy upper surface 404 and the separation film's glossy lower surface 306. This first interface I1, being glossy, passes the first diffused light through without significant distortion. The first diffused light then passes through the separation film 302 and through the film's matte upper surface 304 and is further diffused into second diffused light. The second diffused light then provides an even distribution of light to the layer of resin above the separation film assembly 300 within the resin reservoir 100 to cure the layer.

### Light Diffusing Arrangement 4

In some embodiments, the separation film's upper surface 304 includes a matte finish and its lower surface 306 includes a glossy finish. The light diffusing film's upper surface 404 has a matte surface finish and its lower surface 406 is a glossy surface finish. In addition, the substrate body's upper surface 504 and lower surface 506 each have a glossy surface finish. Given this, the first interface I1 is an interface of the separation film's lower surface 306 and light diffusing film's matte upper surface 404, and the second interface I2 is an interface of the light diffusing film's glossy lower surface 406 and the substrate body's glossy upper surface 504.

In this arrangement, the first light L1 first passes through the substrate body's glossy lower surface 506 and remains relatively unaffected. The light then passes through the second interface I2 comprising the substrate body's glossy upper surface 504 and the light diffusing film's glossy lower surface 406. This second interface I2 allows the light to pass through without significant distortion. The light then transmits through the light diffusing film 402 and through the first interface I1 comprising the light diffusing film's matte upper surface 404 and the separation film's glossy lower surface 306. This first interface I1, being matte due to the light diffusing film's matte upper surface 404, diffuses the light into first diffused light. The first diffused light then passes through the separation film 302 and through the film's matte upper surface 304 and is further diffused into second diffused light. The second diffused light then provides an even distribution of light to the layer of resin above the separation film assembly 300 within the resin reservoir 100 to cure the layer.

### Light Diffusing Arrangement 5

In some embodiments, the separation film 302 comprises a transparent plastic such as, but not limited to, Polymethylpentene (PMP), e.g., a TPX™ film from Mitsui Chemicals. In some embodiments, the PMP film includes a glossy upper surface 304 and a matte lower surface 306. The light diffusing film 402 is replaced by a sheet of tempered glass with glossy upper and lower surfaces, and the substrate body 502 has an etched upper surface 504 and a glossy lower surface 506. Given this, the first interface I1 is an interface of the separation film's matte lower surface 306 and the tempered glass's glossy upper surface 404, and the second interface I2 is an interface of the tempered glass's glossy lower surface 406 and the substrate body's etched upper surface 504.

In this arrangement, the first light L1 first passes through the substrate body's glossy lower surface 506 and remains relatively unaffected. The light then passes through the second interface I2 comprising the substrate body's etched upper surface 504 and the tempered glass's glossy lower surface 406. This second interface I2 diffuses the light into first diffused light due to the substrate body's etched upper surface 506. The first diffused light transmits through the tempered glass and through the first interface I1 comprising the tempered glass's glossy upper surface 404 and the separation film's matte lower surface 306. This first interface I1, being matte, diffuses the first diffused light further into second diffused light. The second diffused light then passes through the separation film 302 and through the film's glossy upper surface 304 and provides an even distribution of light to the layer of resin above the separation film assembly 300 within the resin reservoir 100 to cure the layer.

FIG. 4 illustrates a table including the specifications of the various finishes of the surfaces 404, 406 of the light diffusing element 402 and the surfaces 504, 506 of the rigid substrate body 502 for each of the arrangements 1-5 described herein. For example, the table shows the light diffusing film's material, haze, and transmittance specifications, the rigid substrate's material and roughness specifications, and the overall transparency rating for each.

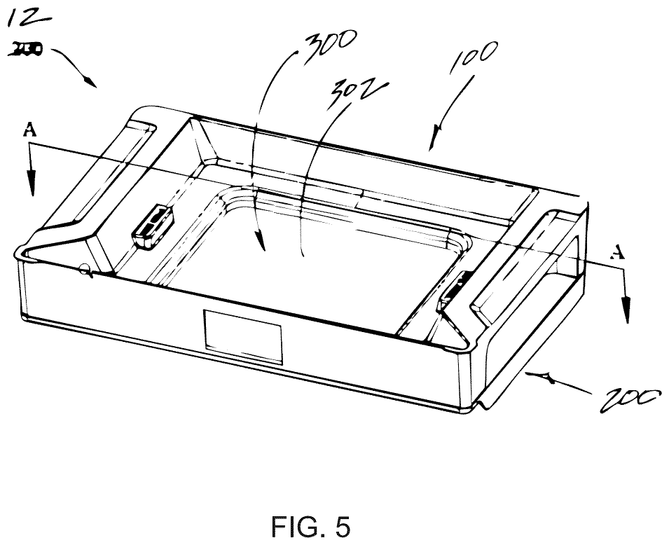

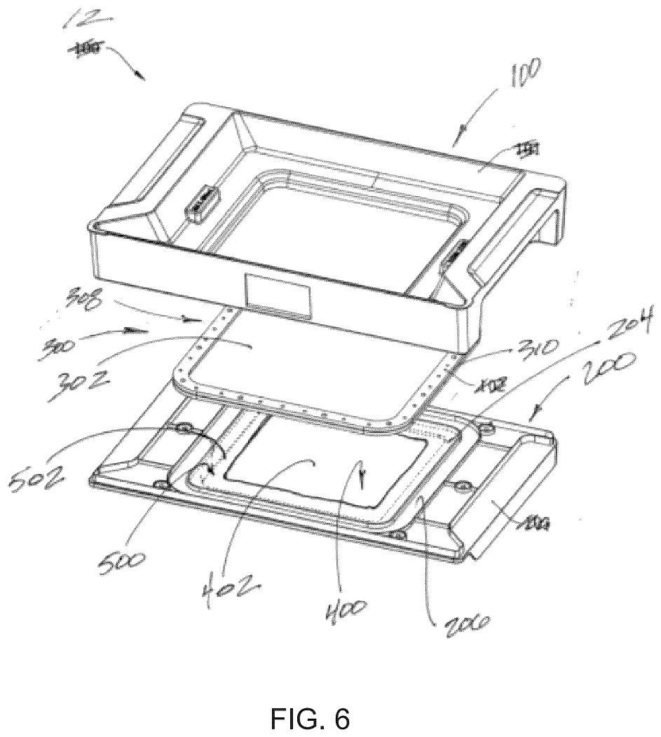

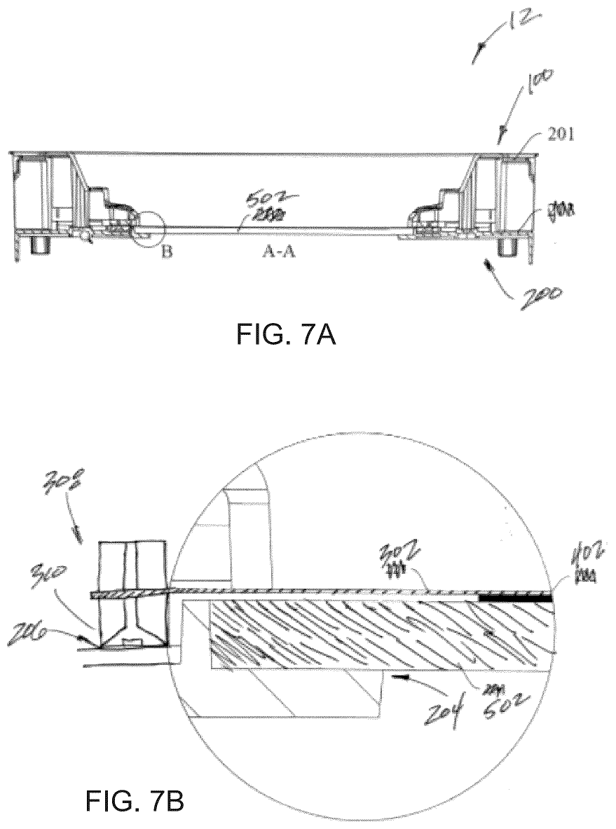

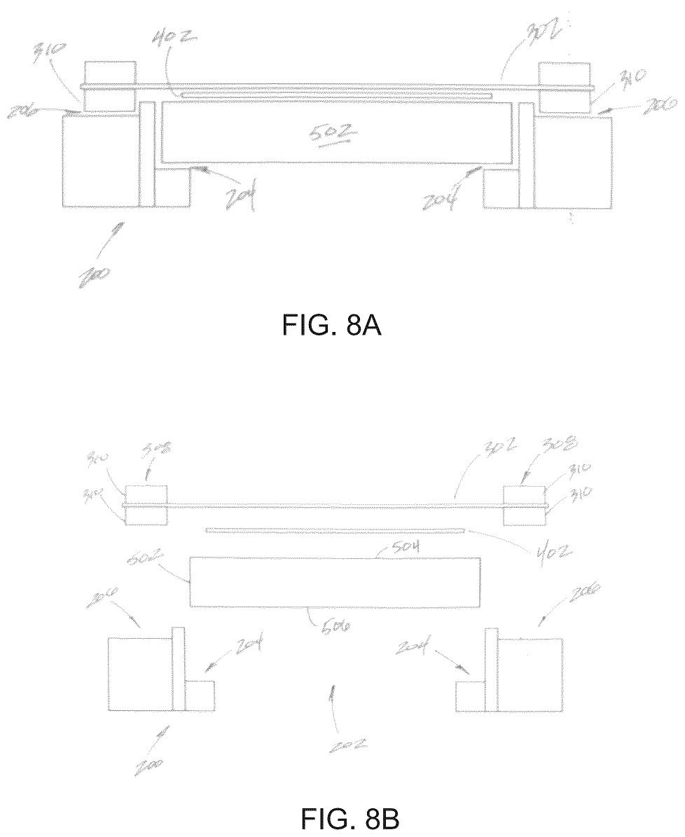

FIG. 5 illustrates an exemplary implementation of the resin tank system 12, wherein the resin tank system 12 may include a resin tank body 100, a resin tank base assembly 200, a separation film assembly 300, a light diffusing element 400, and a rigid substrate 500. FIG. 6 illustrates an exploded view of the same. FIG. 7A illustrates a sectional view of the system 10 taken along cutlines A-A of FIG. 4, and FIG. 7B illustrates a close-up view of the portion B of FIG. 7A. In addition, FIG. 8A illustrates a generalized block diagram of the system 10 of FIGS. 5-7, and FIG. 8B illustrates an exploded view of the same.

In some embodiments, as illustrates in FIGS. 5-8, the separation film 302 may be held flat with its perimeter held within a bracket 308, wherein the bracket 308 may comprise upper and lower bracket rings 310 (e.g., comprising metal or other suitable material), each with an inner aperture where the separation film 302 may be unobstructed. This holds the separation film 302 taut.

In some exemplary embodiments, as illustrated in FIGS. 7B and 8A, the resin tank base assembly 200 may include a lower aperture 202 (e.g., to receive light L1) defined by a first (e.g., inner) peripheral ledge 204. As illustrated in FIG. 7A, the inner ledge 204 may include a width and depth sized and positioned to receive and support a peripheral portion of the rigid substrate body 502 and its lower surface 506. Additionally, the base assembly 200 also may include a second (e.g., upper) ledge 206 with a width and depth sized and positioned to receive a peripheral portion of the separation film 302, e.g., a portion of the separation film's bracket 308 (e.g., the bracket's lower ring 310) while placing the separation film 302 in its proper position above the upper surface 504 of the rigid substrate body 502 as required by the 3D printing process. As illustrated in FIG. 8A, the second ledge 206 and the peripheral portion of the separation film 302 supported thereby may be outside the first ledge 204 and the peripheral portion of the rigid substrate body 502.

In some exemplary embodiments, as illustrated in FIGS. 7B, 8A, and 8B, the light diffusing film 402 may be disposed (e.g., sandwiched) between the rigid substate's upper surface 504 and the separation film's lower surface 306.

In exemplary some embodiments, with the rigid substate body 502 received into the inner ledge 204, the light diffusing film 402 placed on top of the rigid substrate's upper surface 504, and the separation film 302 (held within its bracket 308) received into the upper ledge 206, the resin tank body 100 may be installed onto the resin tank base 200 (preferably releasably locked) to clamp and/or otherwise hold the rigid substate body 502, the light diffusing film 402, and the separation film 302 in their proper locations and arrangement. This configuration also locks the resin tank base 200 to the resin tank body 100 thereby providing the resin tank assembly 12 as a single unit. In this way, the reservoir tank assembly 12 is modular.

Given the above, to reconfigure the assembly 12 to provide the various light diffusing arrangements as described herein, the resin tank body 100 is simply unlocked and removed from the resin tank base 100 such that the rigid substate body 502, the light diffusing film 402, and/or the separation film 302 each or all may be removed, replaced, interchanged, and/or otherwise reconfigured as desired.

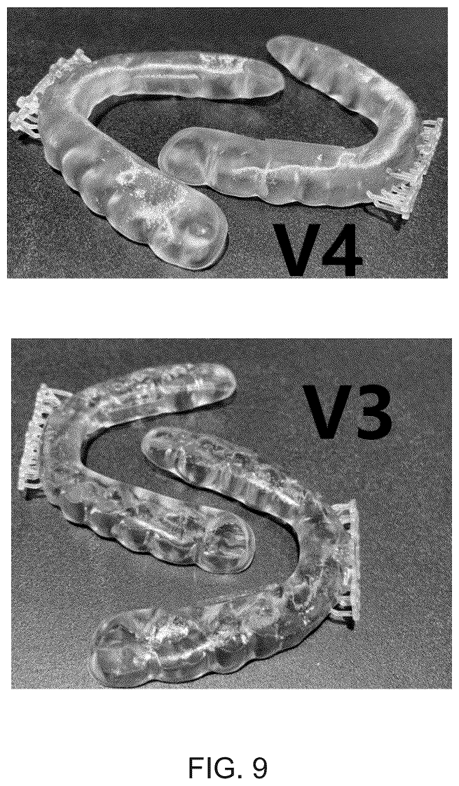

FIG. 9 shows a first dental appliance (top) 3D printed without using the separation film assembly 300, the light diffusing element 400, and the rigid substrate 500 as described herein, and a second dental appliance (bottom) 3D printed while using the separation film assembly 300, the light diffusing element 400, and the rigid substrate 500 as described herein. As seen, the dental appliance printed using the separation film assembly 300, the light diffusing element 400, and the rigid substrate 500 as described herein shows a higher transparency appearance and percentage compared to the appliance printed using a traditional separation film and rigid substrate.

### Model Reorientation Embodiments

As is known, in order to 3D print an object (a “part”), a digital model of the object (e.g., a CAD file) must first be developed. The digital model is then prepared for the 3D printing process by converting the CAD file into machine language (e.g., geometric code or “G-code”) that the 3D printer may recognize and use to print the object. During this preparation, slicing software 206 may be used to calculate and divide (slice) the digital object represented in the CAD file into a multitude of planar two-dimensional layers that the 3D printer may sequentially print one-at-a-time, bonding each new layer to the layer before it to form the three-dimensional object.

However, prior to slicing the digital model, the model first must be properly oriented, with the orientation generally defined as the alignment of the object within the space of the 3D printer's build volume. This may be referred to as part (or object) orientation or build orientation.

The current state of the art guidelines for choosing the proper model build orientation for an optimized 3D printing of the corresponding object are described below. The priority of the guidelines may depend on part being built, its end purpose, and other considerations.

First, build orientation may have a direct effect on the quantity and placement of support structures necessary to support the part during the build. The support structures are removed after the printing process and may typically leave “witness marks” on the part surface that may require post processing (e.g., polishing). As such, it may generally be desirable to minimize the total amount of supports required for a given part in order to reduce the post-processing time while minimizing material usage. For example, a build orientation may be chosen to minimize the number and extent of any overhangs on the part which may require support structures. In this way, the number and size of the support structures may be minimized.

Second, print time of the part may be generally calculated as the number of printed layers multiplied by the exposure time of each layer. Accordingly, to reduce the print time, a part may be oriented in a way that reduces the part's overall height.

Third, parts are oftentimes oriented to reduce the “staircase effect” of the surface as it is being built layer-by-layer. As is known, when part surfaces are oriented at an angle other than perpendicular, they are resolved stepwise as they are built resulting in visible steps and layer lines. As such, it may be desirable to orient vertical surfaces along the vertical Z-axis such that the layers are aligned vertically thereby removing the steps. Similarly, horizontal surfaces oriented parallel to the build plate (e.g., in the X-Y plane) may yield smooth surface results.

Other build orientation criteria may include orienting the build to minimize unvented volumes, to preserve part integrity at intersections, to reduce minima, to minimize mechanical stresses applied to the part during the printing process, and other considerations.

Given the above, the build orientation guidance for improving a 3D printed object's surface quality relies on either minimizing the staircase effect by orienting the part vertically, and/or on reducing the number of support structures and the resulting witness spots they leave behind. However, the current state of the art guidance does not include reorienting the build model to reduce surface defects during the build process that may adversely affect the object's surface transparency characteristics.

Accordingly, an inventive system 20 and method of three-dimensionally (3D) printing an object with improved surface transparency characteristics is presented. Specifically, the system 20 and method applies a method of reorienting the build model in a particular way that improves the printed object's transparency properties.

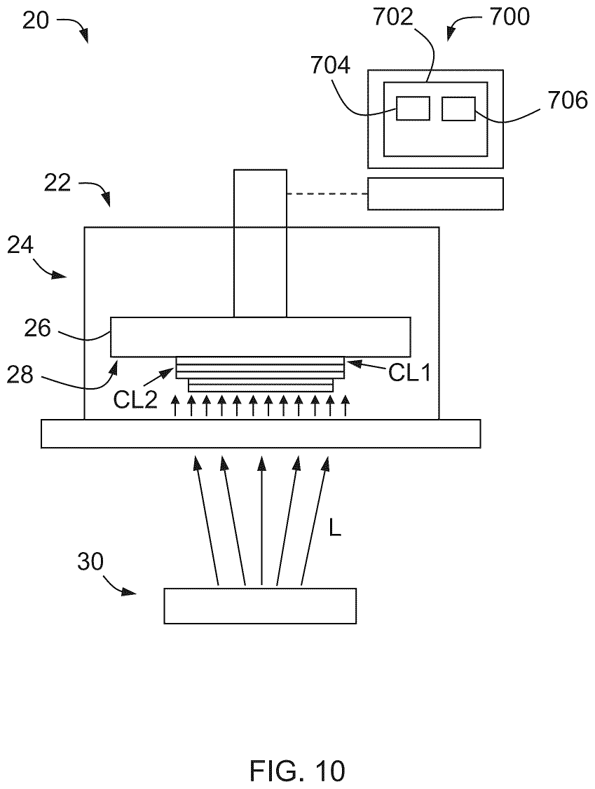

In some embodiments, as shown in FIG. 10, the system 20 includes an additive manufacturing system 22 (e.g., a three-dimensional (3D) printing system) and a controller 700 running software 702, e.g., control software 704 that controls the movements and other aspects of the additive manufacturing system 22, slicing software 706, and other types of software as described herein. The additive manufacturing system 22 may include a resin tank 24 to contain photosensitive resin and a build platform 26 configured within the resin tank 24 and including a lower build surface 28 upon which objects may be printed. The system 22 also may include a light source 30 configured to provide curing light to sequential layers of photosensitive resin beneath the build platform's lower build surface 28 to cure the resin layers (e.g., into cured layers CL1, CL2). The system and method also may include other elements and may provide other functionalities as described herein.

FIG. 10 shows the 3D printing system 22 configured to 3D print an object using a top-down stacking scheme. During this process, each layer of cured resin is formed on the underneath surface of the previously formed layer. As an example, a first cured layer may first be formed directly on the lower build surface 28 of the build platform 26, a second cured layer may then be formed on the lower surface of the first cured layer, a third cured layer may be formed on the lower surface of the second cured layer, and so forth until the entire object is built. It also is appreciated that the system 22 may be configured to print the object using other printing schemes, such as, but not limited to, a bottom-up scheme where each sequential cured layer of resin is built upon an upper surface of the previously cured layer.

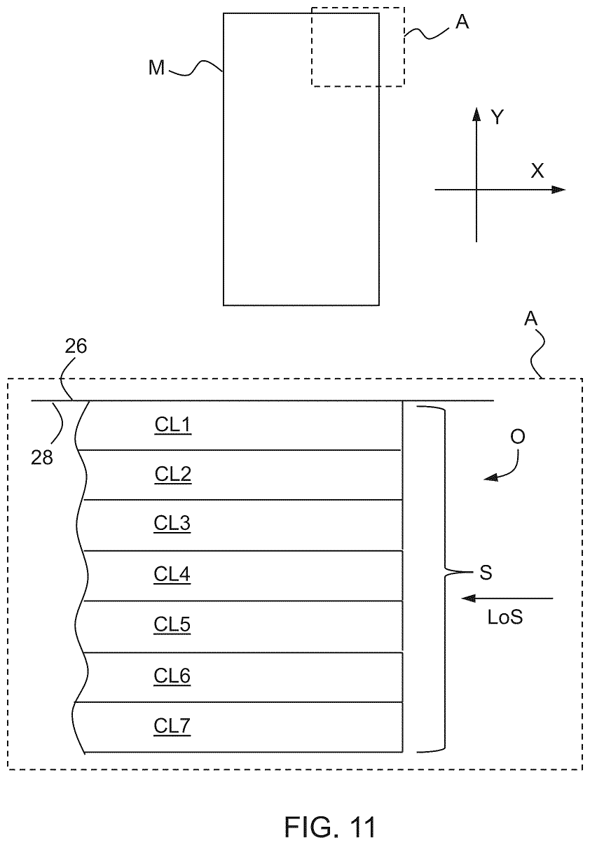

FIG. 11 shows a generalized block diagram front view of a digital model M of an object O to be printed. The object O and its corresponding model M are shown be generally rectangular for demonstration, and it is understood that the object O and its corresponding model M may be any shape or form.

FIG. 11 also shows a close-up view of the portion A of the object's model M being printed using the 3D printing system 100 to form the object O. As shown, the object O is being 3D printed using a top-down stacking scheme wherein sequential layers of cured resin CL1-CL7 are formed one at a time beneath one another. As such, and as is customary for a 3D printing scheme, the model M is oriented vertically as shown so that it may be built downward layer-by-layer without any overhangs that may require support structures. Once the object O is built, the object O will include side surfaces, e.g., the side surface designated as S taken from the line-of-sight LoS in this example.

When 3D printing transparent objects, using photosensitive resin that cures transparent, the side surfaces of the object are oftentimes the limiting factor of the object's overall transparency appearance and percentage. As described in prior sections, if the surface of the printed object includes surface characteristics (e.g., defects) that diminish the object's transparency (e.g., when looking at the surface S from a generally perpendicular line-of-sight LoS as shown in FIG. 11), the object O may appear to have a matte finish and its sides may require polishing to improve the object's overall transparency.

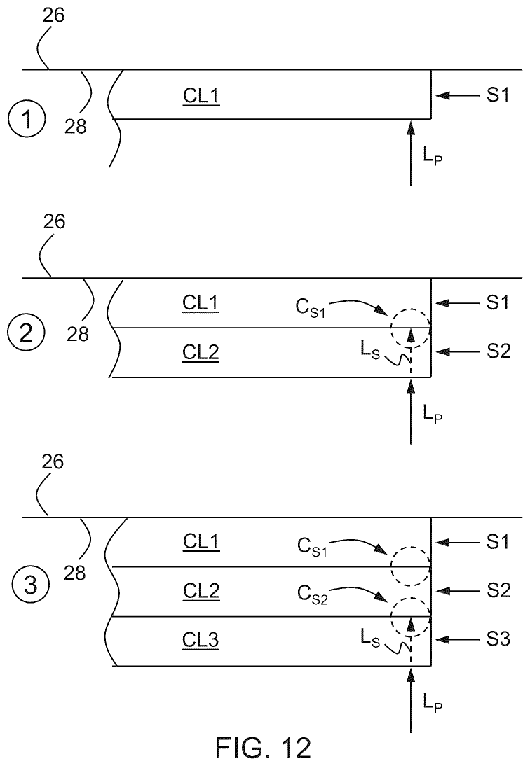

FIG. 12 shows the sequential application of three consecutive layers of cured resin CL1, CL2, and CL3 applied while building the object O. As shown in (1), the first cured layer CL1 is printed directly onto the build surface 28 of the build platform 104. The far-right pixel of light L_{P} cures the far-right edge of the first cured layer CL1 thereby forming the first side section S1 of the object O.

Next, as shown in (2), the second cured layer CL2 may be cured directly to the underside of the first cured layer CL1. The far-right pixel of light L_{P} cures the far-right edge of the second cured layer CL2 thereby forming a second side section S2 of the object directly below the first side section S1. In addition, because the resin material may be transparent (or near transparent) a portion of the light pixel L_{P} (designated as secondary light L_{S} and represented as a dashed arrow) may pass through the cured layer CL2 and irradiate a portion of the prior cured layer CL1. This may cause additional curing to this portion resulting in an overcured portion C_{S1}. For the purposes of this example, the overcured portion C_{S1} is represented generally as a circle. This may take into account the Gaussian profile of the light pixel L_{P} and of the secondary light L_{S} intensity wherein the light L_{P}, L_{S} may have a higher intensity in the inner portions of the pixel and a lesser intensity towards the boundaries of the pixel. It is understood however that this representation is for demonstration and that the actual profile of the overcured portion C_{S1} may depend on a variety of factors including the resin type, the intensity of the light pixels L_{P}, L_{S}, and other factors.

In some cases, the transparency characteristics of the first cured layer CL1 in the area of the overcured portion C_{S} may be adversely affected by the secondary light L_{S}. For example, the overcured portion C_{S1} may cause the lower surface of the first cured layer CL1 in the area of the overcured portion C_{S1} to be uneven, thereby affecting its transparency. For example, the lower surface of the first cured layer CL1 in this area may protrude in the middle of the pixel of light L_{S} where the intensity may be greater and may be less protruded in the outer regions of the light pixel where the intensity may be less. This may result in an uneven surface of the first cured layer CL1 in the area of the overcured portion C_{S} which may be visible as a point defect. Other types of material defects that may adversely affect the object's transparency in other ways also may be caused by the overcuring.

Furthermore, as shown in FIG. 12, a first layer line LL1 at the boundary between the bottom of the first cured layer CL1 and the top of the second cured layer CL2 may be formed, with the far-right end of the first layer line LL1 aligning directly at the junction between the first and second side surfaces S1, S2. This may cause a first visible texture on the side surface at the location of the first layer line LL1.

After the second cured layer of resin CL2 is formed, the 3D printing process may continue by forming a third layer of cured resin CL3 on the lower surface of the second cured layer CL2. In this case, the same phenomenon may occur, and secondary light L_{S} may pass through the third cured layer CL3 and overcure a portion C_{S2} of the second cured layer CL2 as shown. In addition, a second layer line LL2 may be formed between the bottom of the second cured layer CL2 and the top of the third cured layer CL3 and with the far-right end of the second layer line LL2 aligned directly at the junction between the second and third side surfaces S2, S3. This may cause a second visible texture on the side surface at the location of the second layer line LL2.

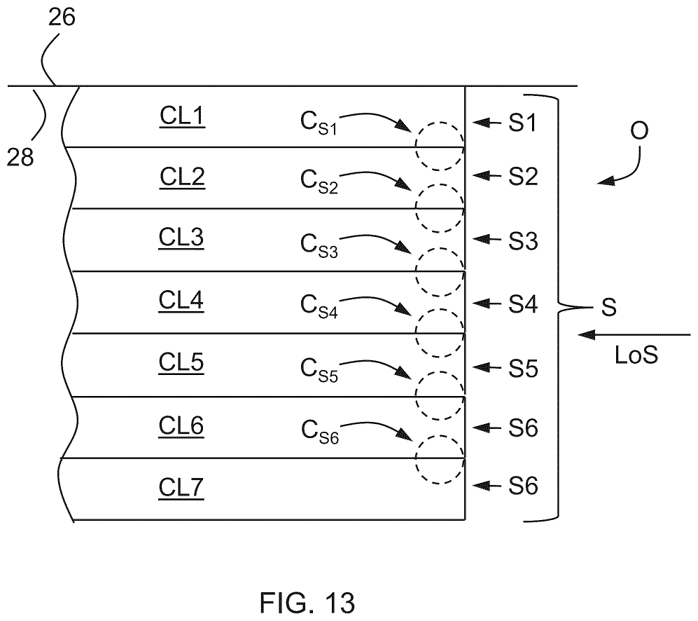

FIG. 13 shows the result of this process while forming seven cured layers CL1-CL7, with each of the cured layers CL1-CL6 including an overcured portion C_{Sn} and a visible layer line LLn between each side surface Sn. As shown, the total side surface S may be formed from the combination of the side surface sections Sn. Looking at the side surface S from the line of site LoS, it can be seen that the overcured portions C_{Sn} and the far-right ends of the layer lines LLn are all aligned directly at the side surface S. As such, the surface characteristic defects caused by the overcured portions C_{Sn} and surface textures caused by the layer lines LLn may be readily visible thereby reducing the object's overall transparency. This may result in the side surface S appearing to have a matte surface finish and the object O having an overall lower transparency appearance and percentage.

In some embodiments of the current invention, the inventors have discovered that by reorienting the object's model M slightly away from the customary vertical orientation during the 3D printing process, the printed object's side surface transparency characteristics may be improved thereby improving the object's overall transparency appearance and percentage. In some embodiments, reorienting the object's model M may result in the overcured portions C_{Sn} being offset from one another (e.g., instead of being aligned together at the side surface S), resulting in less visible surface defects when the printed object's side surface S is viewed from the line-of-sight LoS. This may result in the printed object O having an overall higher transparency appearance and percentage.

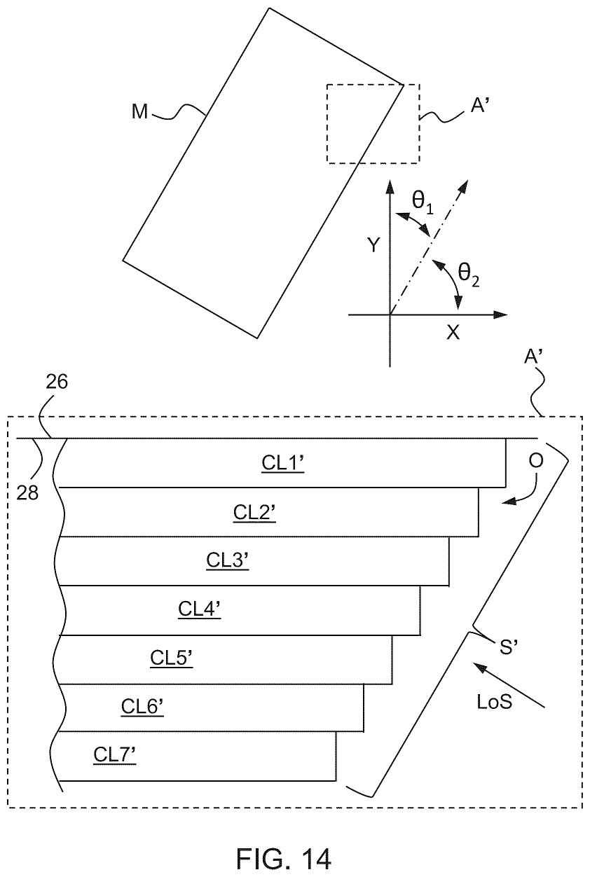

FIG. 14 shows a generalized front block view of the digital model M of the object O of FIG. 10 to be printed according to exemplary embodiments of the invention. As with FIG. 10, the object O and its corresponding model M are shown to be generally rectangular for demonstration, and it is understood that the object O and its corresponding model M may be any shape or form. In some embodiments, as shown in FIG. 13, the object's model M is reoriented away from the customary vertical orientation (along the Y-axis) and is instead purposely oriented at an angle θ₁ where θ₁<90°. In addition, as shown, when the object's model M is reoriented away from the vertical Y-axis by the angle θ₁, the model is reoriented with respect to the horizontal axis (X-axis) by an angle θ₂ where θ₂=90°−θ₁.

FIG. 14 also shows a close-up view of the portion A′ of the object's model M being printed using the 3D printing system 22 to form the object O. As with the prior example, the object O is being 3D printed using a top-down stacking scheme wherein sequential layers of cured resin CL1′-CL7′ are formed one at a time beneath one another. However, instead of being oriented vertically as is customary for a 3D printing scheme, the model M is purposely reoriented at an angle θ₁ where θ₁<90°. Once the object O is built, the object O will include side surfaces, e.g., the side surface designated as S′ taken from the line-of-sight LoS in this example. It is appreciated that this inventive technique also may be applied to other printing schemes, such as, but not limited to, a bottom-up scheme where each sequential cured layer of resin is built upon an upper surface of the previously cured layer.

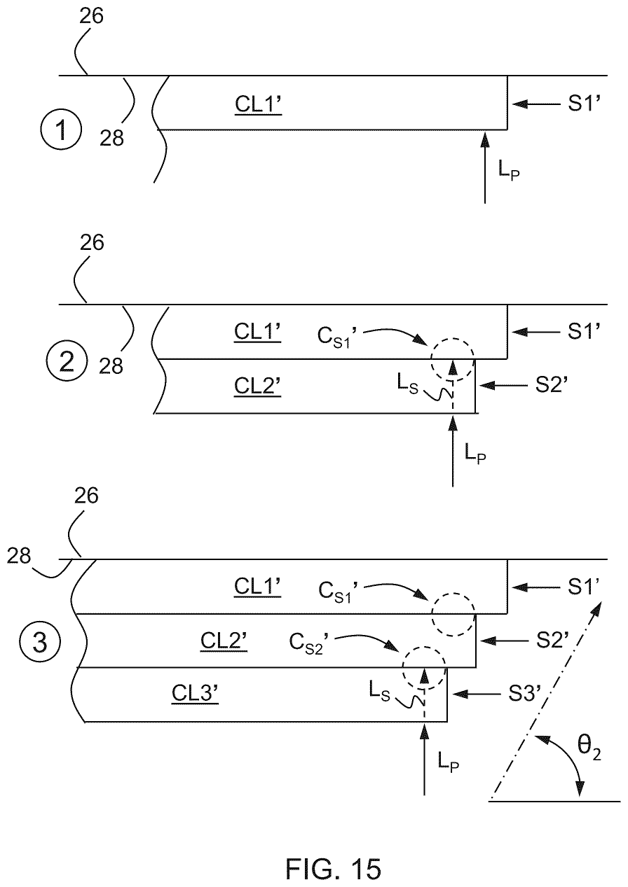

FIG. 15 shows the sequential application of three consecutive layers of cured resin CL1′, CL2′, and CL3′ applied while building the portion A′ of the object O of FIG. 14. As shown in (1), the first cured layer CL1′ is printed directly onto the build surface 28 of the build platform 26. The far-right pixel of light L_{P} cures the far-right edge of the first cured layer CL1 thereby forming the first side section S1′ of the object O.

Next, as shown in (2), the second cured layer CL2′ may be cured directly to the underside of the first cured layer CL1′. The far-right pixel of light L_{P} cures the far-right edge of the second cured layer CL2 thereby forming a second side section S2′ of the object O below and offset to the left of the first side section S1′. As with the prior example, because the resin material may be transparent (or near transparent) a portion of the light pixel L_{P} (designated as secondary light L_{S} and represented as a dashed arrow) may pass through the cured layer CL2′ and irradiate a portion of the previously cured layer CL1′. This may cause additional curing to this portion resulting in an overcured portion C_{S1}′. As with the prior example, the overcured portion C_{S1}′ is represented generally as a circle for demonstration and may include the same or similar characteristics adversely affected by the secondary light L_{S}. However, as shown in (2), the overcured portion C_{S1}′ may be offset to the left of the previously formed first side section S1′ due to the object's model M reorientation.

Furthermore, as shown in FIG. 15, a first layer line LL1′ at the boundary between the bottom of the first cured layer CL1 and the top of the second cured layer CL2 may be formed, with the far-right end of the first layer line LL1′ offset to the left of the junction between the first and second side surfaces S1, S2. Given this offset, any surface texture caused by the first layer line LL1′ at the junction between the first and second side surfaces S1′, S2′ also may be offset to the left.

After the second cured layer of resin CL2′ is formed, the 3D printing process may continue by forming a third layer of cured resin CL3′ on the lower surface of the second cured layer CL2′ with its side section S3′ offset to the left of the second side section S2′. In this case, the same phenomenon may occur, and secondary light L_{S} may pass through the third cured layer CL3′ and overcure a portion C_{S2}′ of the second cured layer CL2′ as shown. However, the overcured portion C_{S2}′ may be offset to the left of the first overcured portion C_{S1}′ and to the left of the previously formed second side section S2′ due to the object's model M reorientation. In addition, a second layer line LL2′ may be formed between the bottom of the second cured layer CL2 and the top of the third cured layer CL3 and with the far-right end of the second layer line LL2′ offset to the left of the junction between the second and third side surfaces S2′, S3′. Given this offset, any surface texture caused by the second layer line LL2′ at the junction between the second and third side surfaces S2′, S3′ also may be offset to the left.

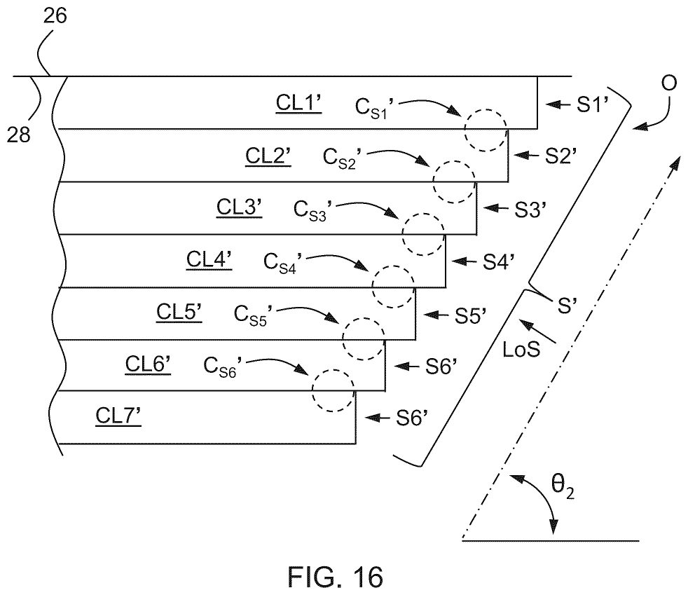

FIG. 16 shows the result of this process while forming seven cured layers CL1′-CL7′, with each of the cured layers CL1′-CL6′ including an overcured portion C_{Sn}′ and a visible layer line LLn′ each offset to the left of the previously overcured portion C_{Sn-1}′ and the previous visible layer line LLn-1′ and offset to the left of the previously formed side section Sn-1′. In this example, the horizontal offset between each sequential side surface Sn′ is shown to be equal to about the width of the pixel of light L_{P}. However, it is understood that this was done for demonstrational purposes and for an ease of understanding of the overall inventive concept. It also is understood that the horizontal offsets may be chosen to be other lengths relative to the width of the pixel of light L_{P} depending on the shape and/or form of the object O being printed (and of its model M), and/or on other factors. This will be described in other sections.

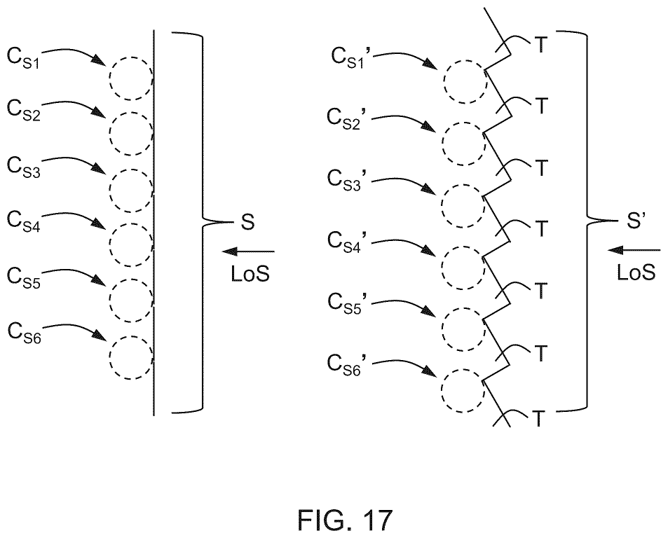

The left drawing in FIG. 17 shows the resulting side surface S of FIG. 13 (printed using the customary vertical model M orientation during the printing process) and its associated defects C_{S1}-C_{S6} and layer lines LL1-LL6, and the right drawing of FIG. 17 shows the resulting side surface S′ of FIG. 15 (printed using the purposely reoriented model M) and its associated defects C_{S1}′-C_{S6}′ and layer lines LL1′-LL6′. Note that the side surface S′ of FIG. 15 has been oriented to vertical so that it may be compared directly to the vertical side surface S.

As shown in the left drawing of FIG. 17, the defects C_{Sn} and the far-right ends of the layer lines LLn are all aligned directly at the side surface S, and as such, may cause surface anomalies that may adversely affect the surface's transparency characteristics when viewed from the line-of-sight LoS. As a result, the side surface S may appear to have a matte finish and may require polishing.

However, as shown in the right drawing of FIG. 17, the defects C_{Sn}′ and the far-right ends of the layer lines LLn' are seen to be offset behind the surface S′ by portions T (e.g., outer facing corners or steps) of unaffected cured resin. The inventors have discovered that it is this offsetting of the defects C_{Sn}′ and the far-right ends of the layer lines LLn' behind these portions T of unaffected cured resin that improves the surface transparency of the printed object O. The inventors also have discovered that offsetting the model M by an reorientation angle θ₁ also may help to minimize the trapping of uncured resin in small crevices and/or intricate details of the model M, thereby achieving a more thorough cure while preventing the presence of resin residue on the surface S′. As such, the side surface S′ may appear to have a more polished finish and may not require polishing.

In some embodiments, the inventors have discovered that a reorientation angle θ₁ of the object's model M with respect to the vertical of about 10° to about 40° (10°≤θ₁ ≤40°), or stated another way, to a reorientation angle θ₂ with respect to the horizontal of about 60° to about 80° (60°≤θ₂ ≤80°) results in a significantly improved transparency appearance, while reorientation angles θ2 with respect to the horizontal of about 0° to 60° (0°≤θ₂ <60°) and of about 80° to 90° (80°<θ₂ ≤90°) may provide less transparency improvement.

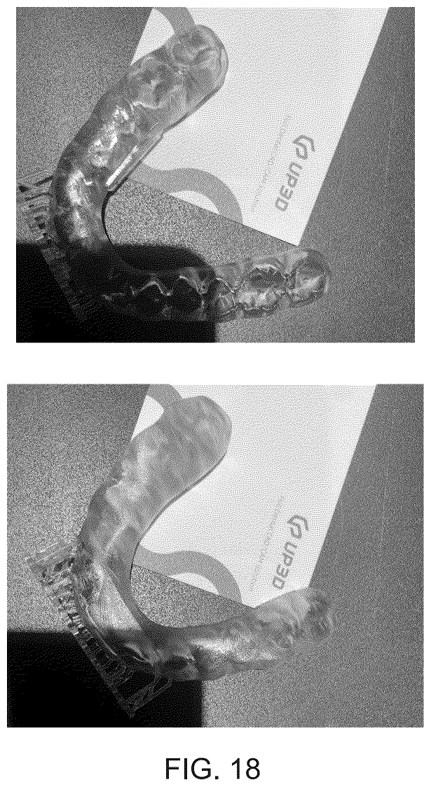

FIG. 18 shows a first dental appliance 3D printed using the traditional vertical orientation of the part's model (in the top picture), and a second dental appliance 3D printed using the reorientation method described herein (in the bottom picture). As seen, the dental appliance in the lower picture printed at the offset orientation θ shows a higher transparency appearance and percentage compared to the appliance 3D in the upper picture printed using traditional orientations.

In some embodiments, the system 10 includes software 702 running on the controller 700. The software 702 may include control software 704 that controls the movements and other aspects of the build platform 702, slicing software 706 that converts a three-dimensional model of the object to be 3D printed (e.g., a CAD model such as an STL file) into machine language (e.g., geometric code or “G-code”) that the 3D printer may recognize and use to print the object, and other types of software. The slicing software 706 may generally calculate and divide (slice) the digital object represented in the CAD file into a multitude of planar two-dimensional layers that the 3D printer may sequentially print one-at-a-time, bonding each new layer to the layer before it to form the three-dimensional object.

In some embodiments, the slicing software 706 (or other associated software) also may determine the optimal reorientation angle θ₂ that may result in an optimal transparency appearance of the printed object O. The software 706 may then use this optimal reorientation angle θ2 to reorient the object's model M (to the angle θ₂ with respect to the horizontal) for 3D printing the object O.

In some embodiments, the software 706 may systematically orient the object's model M to different angles θ₂ (with respect to the horizontal axis) and may analyze each resulting surface profile at each reoriented angle θ2. For example, the software 206 may orient the object's model M to θ₂=50°, 60°, 70°, and 80°, while analyzing the resulting surface profile at each reorientation angle θ₂.

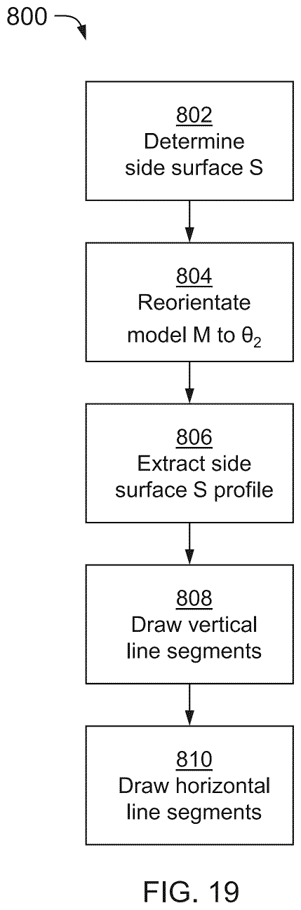

In some embodiments, as shown in FIG. 19, the software 706 may perform the following actions 800:

At 802, the software 706 may determine a side surface S of the object's model M to be optimized with regards to transparency. At 804, the software 706 may reorient the model M to place the side surface S at a first reorientation angle θ₂. For example, the software 706 may reorient the model to a reorientation angle θ₂=50°. The software 706 may then, at 806, extract the side profile of the side surface S.

At 808, the software 706 may then draw vertical line segments (e.g., overlaid the side surface S profile from 806) that represent the offsets (e.g., steps) of the side surface due to the reorientation of the model M. For example, for each step between adjacent white and black pixels, the software may draw a vertical line segment between the adjacent white and black pixels. In addition, for each grayscale pixels and adjacent white pixels, the software 706 may draw a vertical line segment with a length that corresponds to the grayscale pixel's value divided by 255 and multiplied by the pixel width. Then, at 810, the software 706 may connected the corresponding ends of the sequential vertical line segments with corresponding horizontal line segments to form the stepped side profile of each aggregate side surface. This process may be repeated for each reorientation angle θ₂ of interest.

It is understood that the actions 800 may be taken in different order(s), not all of the actions 800 must necessarily be taken depending on the application, and that other actions also may be taken.

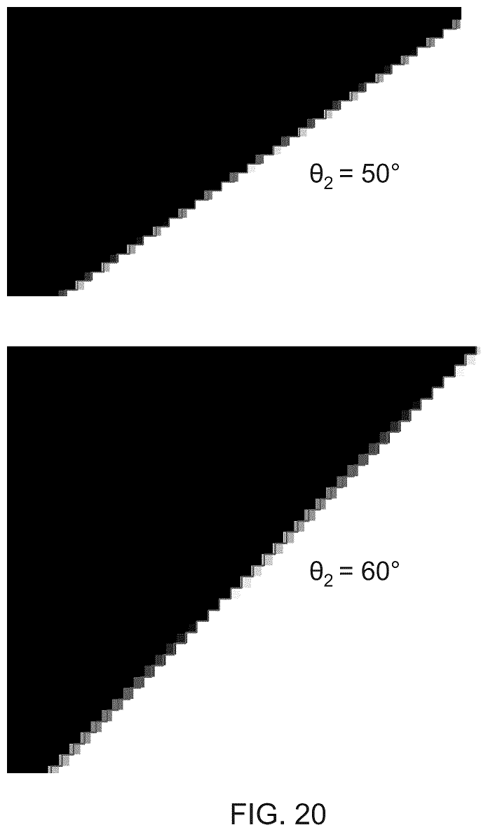

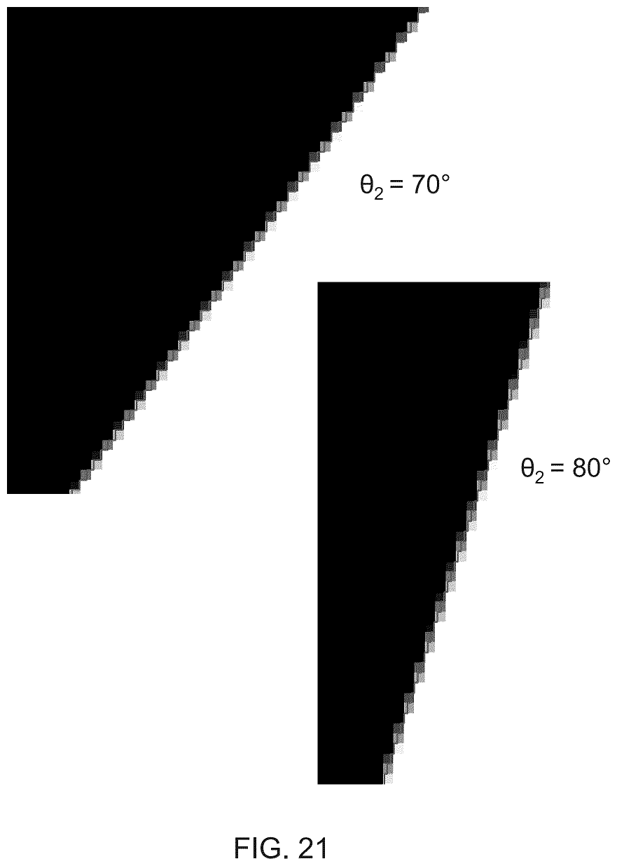

FIGS. 20-21 show the results of this process for reorientation angles θ₂=50°, 60°, 70°, and 80°. The drawn line segments represent the pixel boundaries at the object's side surface S for each reorientation angle θ₂, with the grayscale pixels anti-aliased and generally equal to the ratio of the grayscale pixel value to the full pixel value.

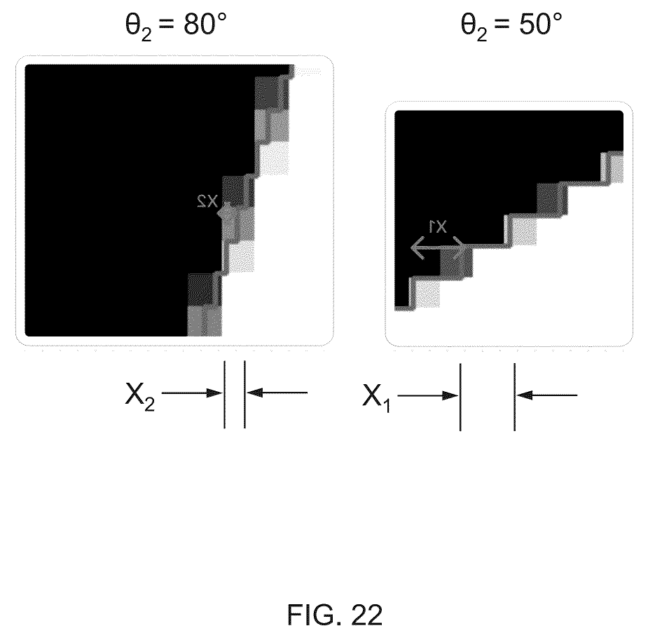

FIG. 22 shows the line segments drawn in 600 extracted from the model's side surface profiles and shown individually for comparison. The line segments have each been oriented horizontally for comparison purposes.

In some embodiments, the inventors have determined that the side surface profiles resulting from θ₂=60°, 70°, and 80° result in an improved surface transparency, with θ₂=80° showing the most surface transparency improvement of the reorientation angles θ₂ used in this example. This may be due to the fact that the transition step sizes shown in FIGS. 21-23 for θ₂=80° are the smallest of the set but still readily noticeable thereby providing a more polished finish. In addition, the step sizes for θ₂=50°, 60°, and 70° may be larger and with longer horizontal segments between sequential steps thereby causing a more matte finish.

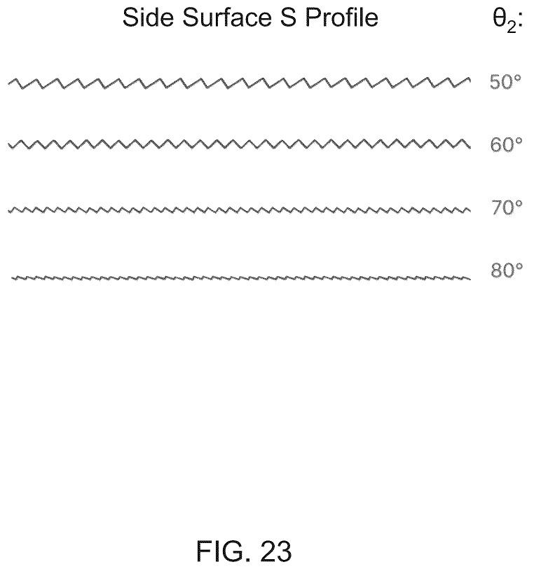

FIG. 23 shows close-up views of the side surface profiles resulting from a reorientation angle θ₂=80° on the left and θ₂=50° on the right. As shown, the θ₂=80° profile includes a cured layer offset width X₂, and the θ₂=50° profile includes a cured layer offset width X₁, with the cured layer offset width (also referred to as the transition step size) X₁ being greater than that of X₂ (X₁>X₂).

In some embodiments, as shown in FIG. 23, the offset width X₁ for θ₂=50° is equal to or slighter larger than about one single pixel width, and the offset width X₂ for θ₂=80° is equal to about one-third of a single pixel width, with the offset width X₂ providing an improved surface transparency profile than that of the offset width X₁.

In some embodiments, the inventors have determined that a purposely cured layer offset width equal to about one-eighth of a single pixel width to about seven-eighths of a single pixel width improves the surface transparency characteristics of the printed object, and preferably, a purposely cured layer offset width of about one-fourth of a single pixel width to about three-fourths of a single pixel width improves the surface transparency characteristics of the printed object, and more preferably, a purposely cured layer offset width of about three-eighths of a single pixel width to about five-eighths of a single pixel width improves the surface transparency characteristics of the printed object, and more preferably, a purposely cured layer offset width of about three-eighths of a single pixel width to about one-half of a single pixel width improves the surface transparency characteristics of the printed object, and more preferably, a purposely cured layer offset width of about one-third of a single pixel width improves the surface transparency characteristics of the printed object.

In some embodiments, as described in other sections, the above described purposely cured layer offset widths may offset various defects in the printing process away from the side surface of the object thereby improving the object's transparency. For example, the above described purposely cured layer offset widths may offset surface textures caused by layer lines between sequentially printed layers of cured resin away from the side surface of the object thereby reducing the visibility of the layer line surface textures. Similarly, the above described purposely cured layer offset widths may offset portions of overcured resin away from the side surface of the object thereby reducing the visibility of these portions. In this way, the object's surface may appear to be smoother, thereby providing a more transparent surface finish.

In addition, as may result when θ₂=80°, for improved transparency characteristics, the transition step size (e.g., X₂ in FIG. 23) may preferably be smaller in size compared to the corresponding cured layer thickness.

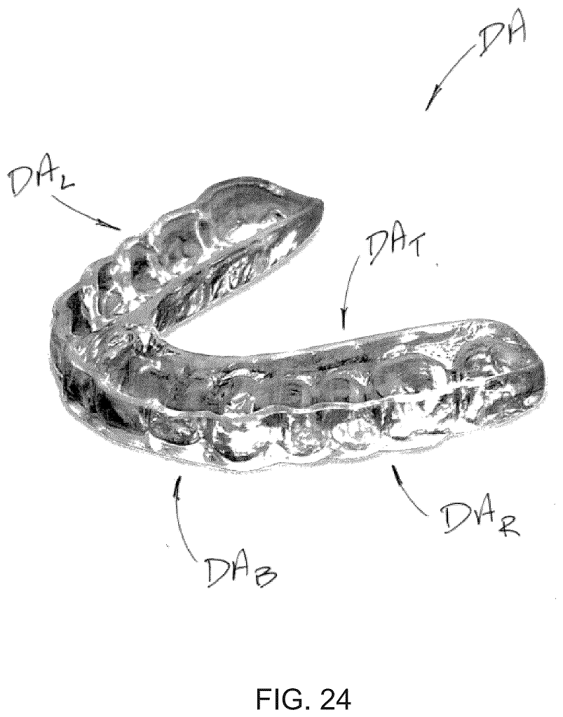

FIG. 24 shows a perspective view of a dental appliance DA that has been 3D printed. As shown, the dental appliance DA includes a topside DA_{T}, a bottom side DA_{B} generally opposite the top side DA_{T}, a left side DA_{L}, and a right side DA_{R}. In use, the dental appliance DA is placed into a patient's mouth such that the patient's teeth enter into the cavity on the topside DA_{T} of the appliance DA.

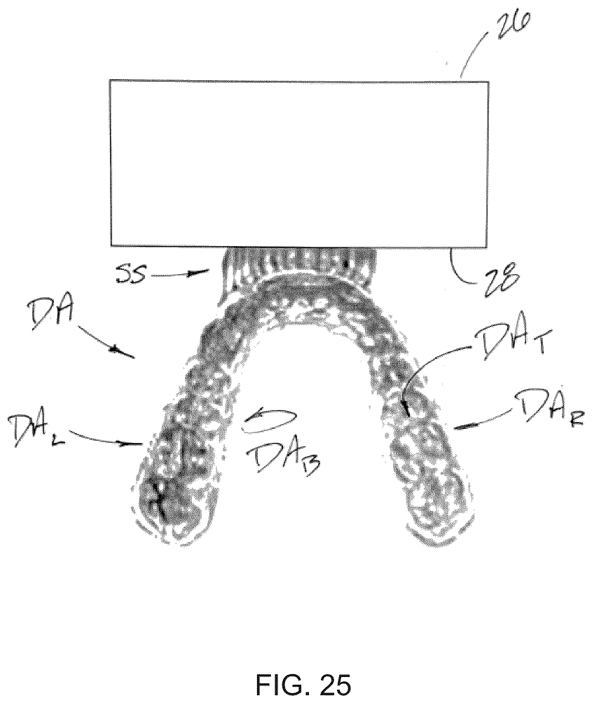

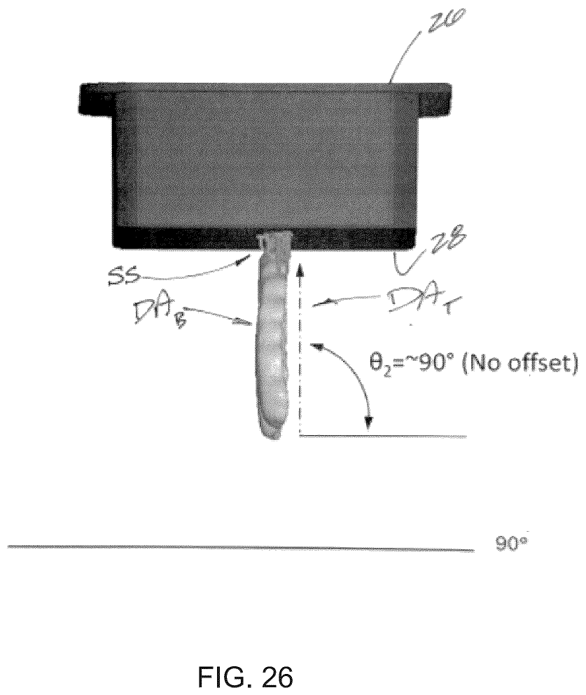

FIG. 25 shows a front view of the dental appliance DA having been 3D printed using a customary model orientation and a top-down stacking scheme beneath the lower build surface 28 of the build platform 26. As shown, printed support structures SS are used to support the body of the dental appliance DA and to link it to the build surface 28 during the printing process. FIG. 26 shows a side view of the same. In preparation for the printing process, the digital model of the dental appliance DA was oriented in a customary position with its top side DA_{T} and its bottom side DA_{B} both oriented vertically with no offset from vertical (i.e., θ₂=90° as shown in FIG. 26). This is reflected in the vertical orientation with no offset from vertical of the resulting printed appliance DA as shown.

FIG. 26 also shows the resulting generalized line segment surface profile of the printed top side DA_{T} and/or of the printed bottom side DA_{B} of the appliance DA (shown horizontally and below the printed appliance image for reference). As shown, the surface profile is linear (with no transition steps) such that the surface transparency characteristics will be compromised for the reasons described herein.

FIG. 27 shows the same dental appliance DA having been 3D printed using the presently disclosed inventive process. That is, in preparation for the 3D printing process, the digital model of the appliance DA was purposely reoriented to position the bottom side DA_{B} and/or the top side DA_{T} of the appliance DA to be at 80° instead of 90° (i.e., θ₂=80°). FIG. 27 also shows the resulting generalized line segment surface profile of the printed top side DA_{T} and/or of the printed bottom side DA_{B} of the appliance DA (shown horizontally and below the printed appliance image for reference). As shown, the surface profile includes transition steps that may improve the surface transparency characteristics of the printed appliance DA for the reasons described herein.

In some embodiments, the purposely cured layer offset width and the resulting transition steps resulting from reorienting the appliance/s model to θ₂=80° are about one-third of a single pixel width thereby improving the appliance's overall transparency characteristics.

In some embodiments, as shown in FIG. 28, the software 706 may perform the following actions 900:

At 902, the software 706 may determine a side surface of the dental appliance's model to be optimized with regards to transparency. For example, the software 706 (and/or the user) may determine to optimize the transparency of the appliance's top side DAT and/or the transparency of its bottom side DA_{B}.

At 904, the software 706 may analyze the surface to be optimized (e.g., DA_{T} and/or DA_{B}) by determining the stepped side profile of each respective surface various potential offset angles θ₂. For example, the software 706 may determine the stepped side profile of each surface for θ₂=75°, 76°, 77°, 78°, 79°, 80°, 81°, 82°, 83°, 84°, and 85°. Note that this set of angles for θ₂ are shown for demonstration and that other sets of angles also may be chosen.

At 906, the software 706 may analyze each resulting stepped side profile for each of the chosen angles θ₂ and may use one or more criterion to determine which offset angle θ₂ to use during the printing process. In some embodiments, a first criterion may be that a transition step size of the side profile resulting from the offset angle θ₂ (e.g., an average transition step size of the side profile) be about one-third of a single pixel width to improve the surface transparency characteristics of the printed appliance. Another criterion may be that a transition step size resulting from the offset angle θ₂ (e.g., an average transition step size of the side profile) be smaller in size compared to the corresponding cured layer thickness. Other criteria also may be used.

Given the results of the analysis at 906, the software 706 may determine (at 908) an offset angle θ₂ to use during the printing process to improve the printed appliance's transparency.

At 910, the software 706 may optionally first orient the appliance's model to a first vertical orientation (e.g., the customary orientation as shown in FIGS. 25 and 26), and then at 912, the software 706 may reorientate the model to place the appliance's front side DA_{T} and/or the appliance's bottom side DA_{B} to the offset angle θ₂ determined in 908.

At 912, the software 706 may cause the dental appliance DA to be printed resulting in the printed dental appliance DA with improved transparency as shown in FIG. 27.

It is understood that the actions 900 may be taken in different order(s), not all of the actions 900 must necessarily be taken depending on the application, and that other actions also may be taken.

It is understood that any aspect or element of any embodiment of the system 10 and method described herein or otherwise may be combined with any other aspect or element of any other embodiment of the system 10 and method to form additional embodiments of the system 10 and method, all of which are within the scope of the system 10 and method.

### Computing

The services, mechanisms, operations, and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

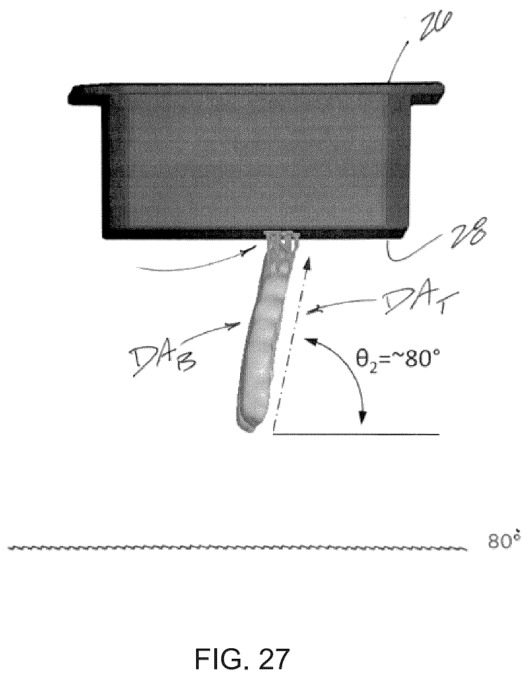

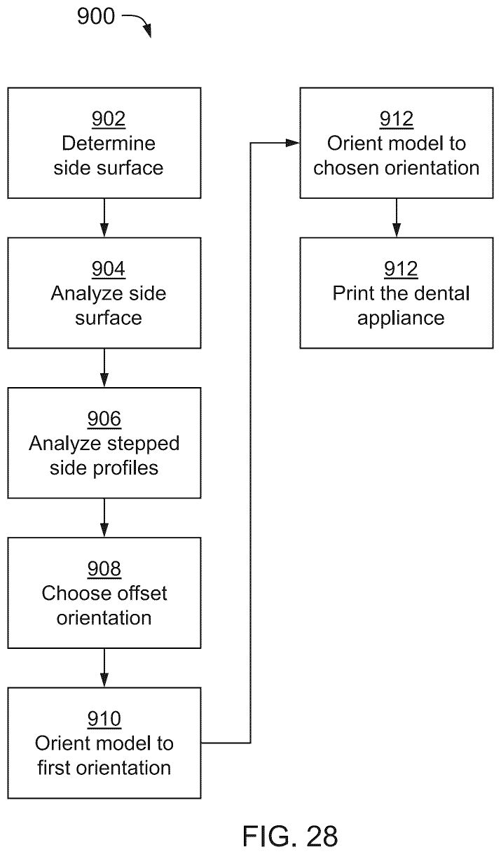

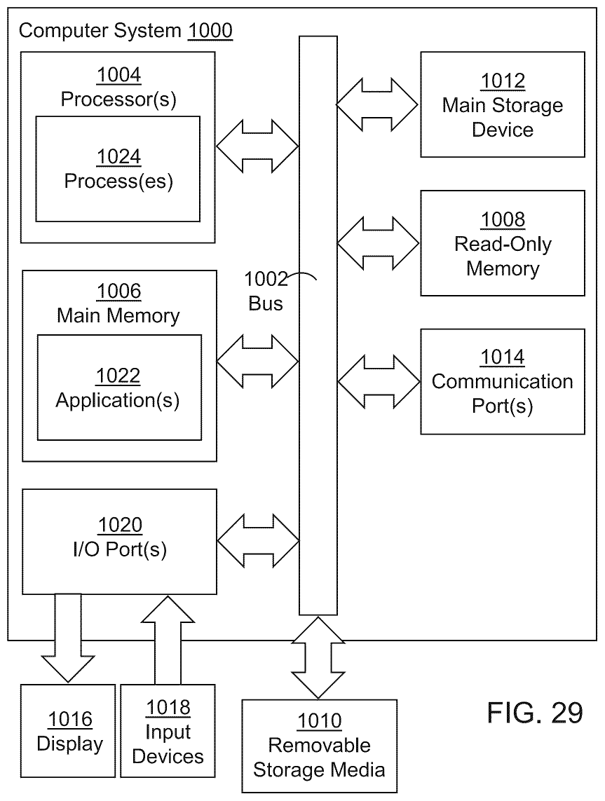

FIG. 29 is a schematic diagram of a computer system 1000 upon which embodiments of the present disclosure may be implemented and carried out.

According to the present example, the computer system 1000 includes a bus 1002 (i.e., interconnect), one or more processors 1004, one or more communications ports 1014, a main memory 1010, removable storage media 1010, read-only memory 1008, and a mass storage 1012. Communication port(s) 1014 may be connected to one or more networks by way of which the computer system 1000 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1004 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 1014 can be any of an RS-232 port for use with a modem-based dial-up connection, a 10/100 Ethernet port, a Gigabit port using copper or fiber, or a USB port, and the like. Communications port(s) 1014 may be chosen depending on a network such as a Local Area Network (LAN), a Wide Area Network (WAN), a CDN, or any network to which the computer system 1600 connects. The computer system 1000 may be in communication with peripheral devices (e.g., display screen 1010, input device(s) 1018) via Input/Output (I/O) port 1020. Some or all of the peripheral devices may be integrated into the computer system 1000, and the input device(s) 1018 may be integrated into the display screen 1010 (e.g., in the case of a touch screen).

Main memory 1010 can be Random Access Memory (RAM), or any other dynamic storage device(s) commonly known in the art. Read-only memory 1008 can be any static storage device(s) such as Programmable Read-Only Memory (PROM) chips for storing static information such as instructions for processor(s) 1004. Mass storage 1012 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 1002 communicatively couples processor(s) 1004 with the other memory, storage and communications blocks. Bus 1002 can be a PCI/PCI-X, SCSI, a Universal Serial Bus (USB) based system bus (or other) depending on the storage devices used, and the like. Removable storage media 1010 can be any kind of external hard-drives, floppy drives, IOMEGA® Zip Drives, Compact Disc—Read Only Memory (CD-ROM), Compact Disc—Re-Writable (CD-RW), Digital Versatile Disk—Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor, or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g., sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 1010 is encoded with application(s) 1022 that support(s) the functionality as discussed herein (an application 1022 may be an application that provides some or all of the functionality of one or more of the mechanisms described herein). Application(s) 1022 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 1004 accesses main memory 1010 via the use of bus v02 in order to launch, run, execute, interpret, or otherwise perform the logic instructions of the application(s) 1022. Execution of application(s) 1022 produces processing functionality of the service(s) or mechanism(s) related to the application(s). In other words, the process(es) 1024 represents one or more portions of the application(s) 1022 performing within or upon the processor(s) 1004 in the computer system 1000.

It should be noted that, in addition to the process(es) 1024 that carries (carry) out operations as discussed herein, other embodiments herein include the application 1022 itself (i.e., the un-executed or non-performing logic instructions and/or data). The application 1022 may be stored on a computer readable medium (e.g., a repository) such as a disk or in an optical medium. According to other embodiments, the application 1022 can also be stored in a memory type system such as in firmware, read only memory (ROM), or, as in this example, as executable code within the main memory 1010 (e.g., within Random Access Memory or RAM). For example, application 1022 may also be stored in removable storage media 1010, read-only memory 1008, and/or mass storage device 1012.

Those skilled in the art will understand that the computer system 1000 can include other processes and/or software and hardware components, such as an operating system that controls allocation and use of hardware resources.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

### Optical Assembly System

In some exemplary embodiments, the current invention presents an advanced optical assembly system for LCD-based 3D printing that fundamentally improves print quality through enhanced light management. More specifically, the present invention significantly enhances surface quality and transparency of printed objects by incorporating a light-diffusing medium within an image creation or display assembly to modify how UV light interacts with the printing process. By incorporating a specialized diffusion film within the image creation or display assembly, the system may achieve uniform UV light distribution, thereby eliminating contrast inconsistencies during the curing process.

This configuration eliminates surface imperfections typically and undesirably produced in conventional LCD-based 3D printing systems. An exemplary system in accordance with the present invention is adapted to optically polish surfaces directly from the printing process without requiring post-production manual polishing. Accordingly, an optical assembly system for LCD-based 3D printing that significantly enhances surface quality and transparency characteristics of 3D-printed objects is presented.

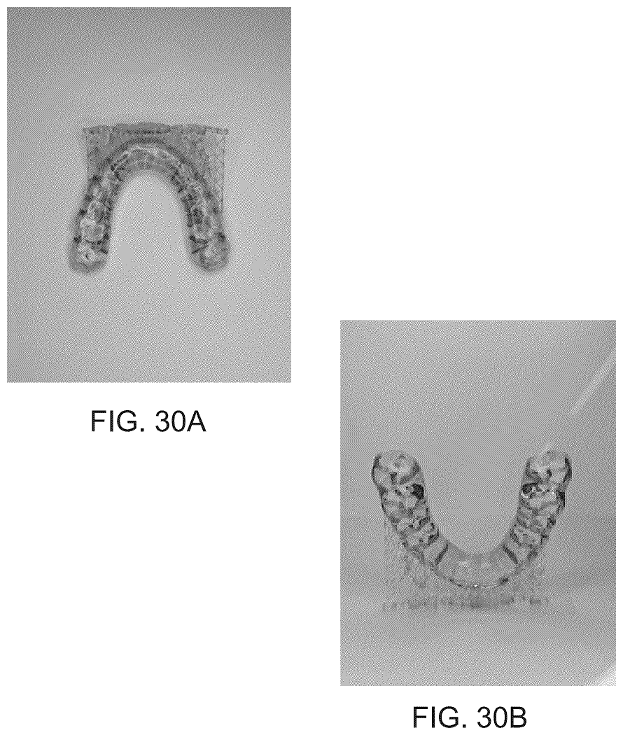

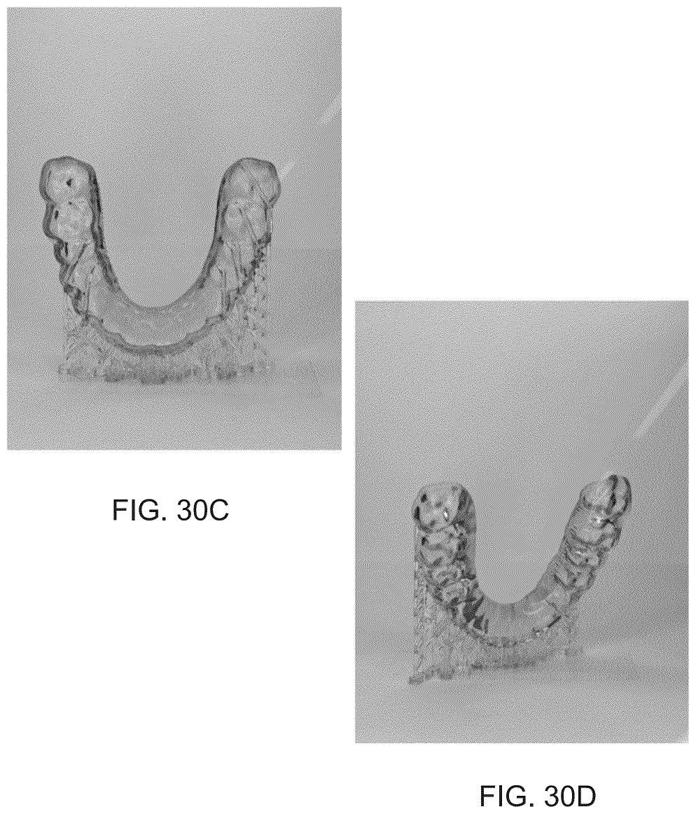

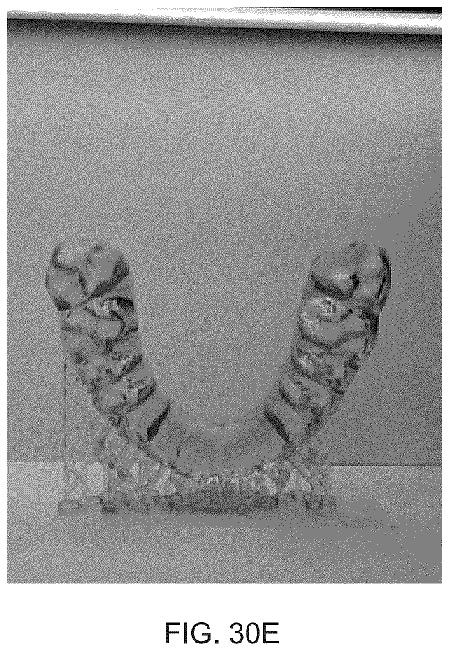

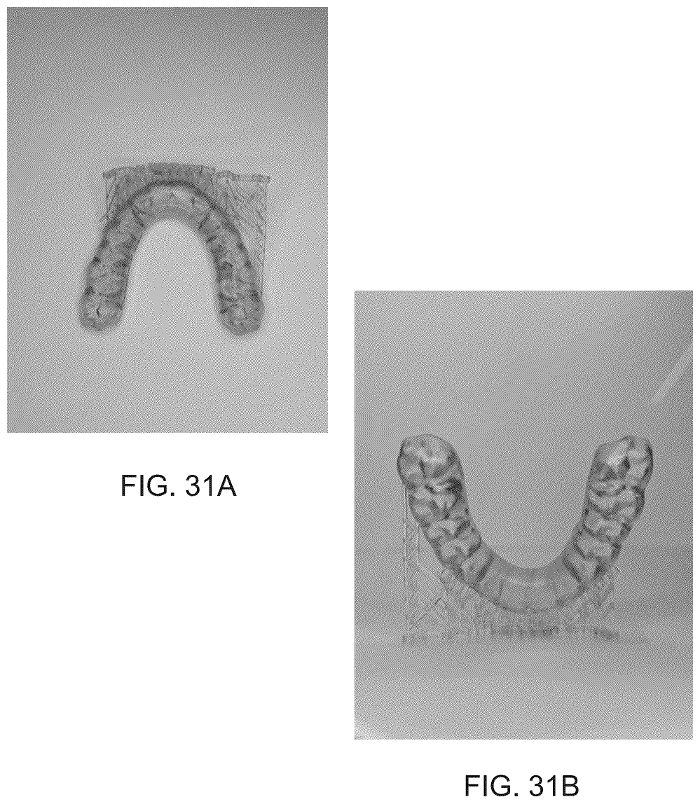

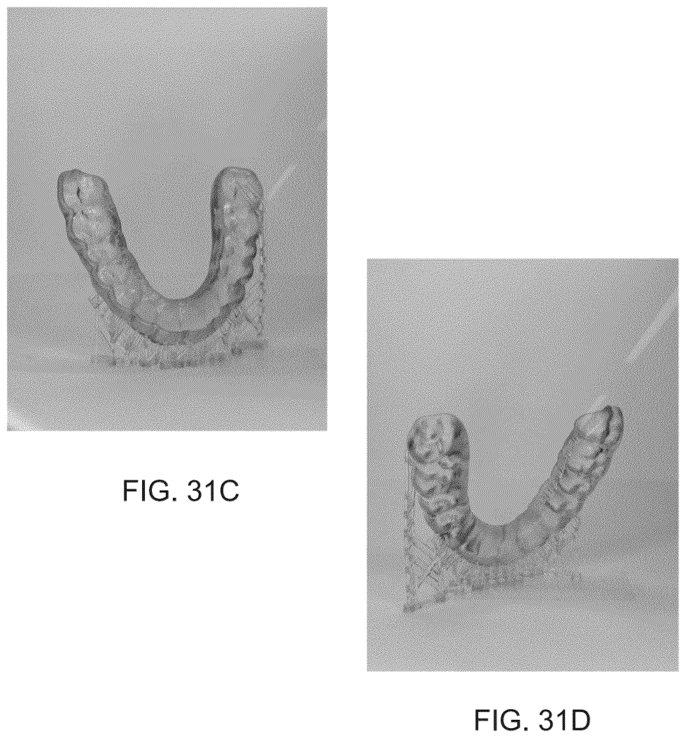

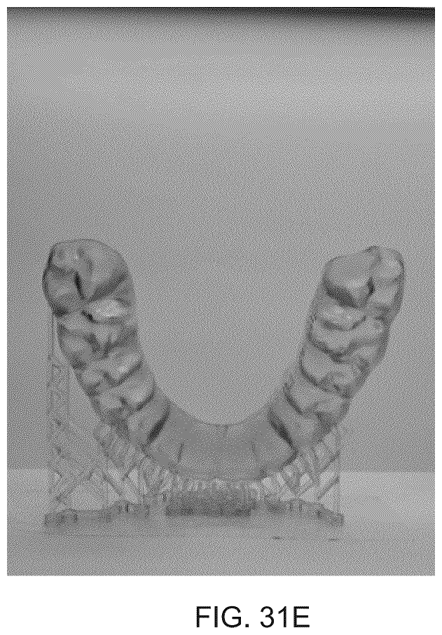

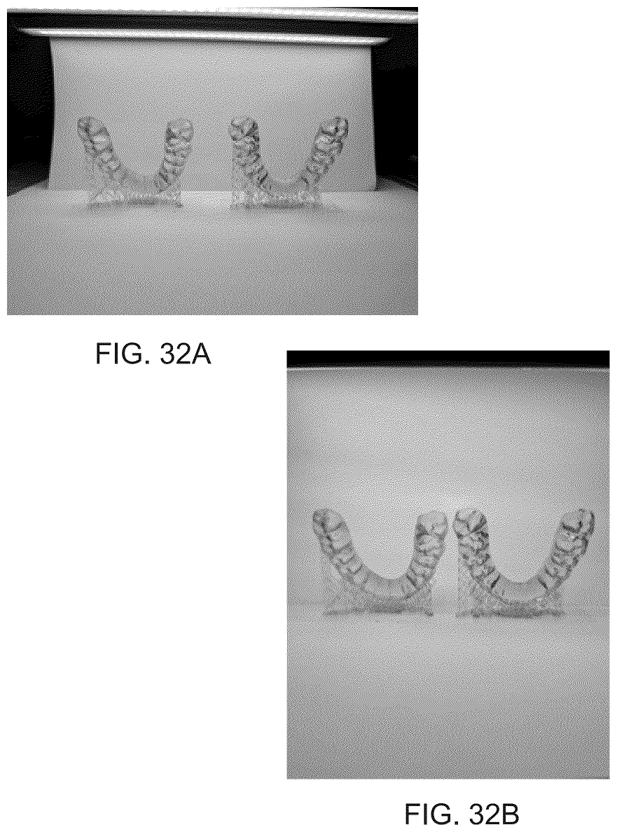

Turning now to the next set of figures, FIGS. 30A-30E illustrate multiple perspective view of a 3D-printed part that has been printed with an exemplary optical assembly system of an LCD-based 3D printer in accordance with the present invention. FIGS. 31A-31E illustrate multiple perspective views of a 3D-printed part that has been printed with a regular LCD assembly. FIGS. 32A-32B illustrate side-by-side comparisons of a 3D-printed part printed with a regular LCD assembly and a 3D-printed part printed with an optical assembly system of an LCD-based 3D printer. As illustrated by FIGS. 32A-32B, an optical assembly system in accordance with the present invention is adapted to significantly enhance surface quality and transparency characteristics of 3D-printed objects in comparison to traditional counterparts printed using conventional LCD-based 3D printers.

In some embodiments, an exemplary system is comprised of a display assembly 400, and a support structure 500 as illustrated in FIG. 34. In some exemplary embodiments, the display assembly 400 may be a light-diffusing element. In some exemplary embodiments, the support structure 500 may be a rigid substrate. In yet another exemplary embodiment, the support structure 500 may be a structural frame. In some exemplary embodiments, an exemplary system may be further comprised of a connection PCB 600 as illustrated in FIG. 34.

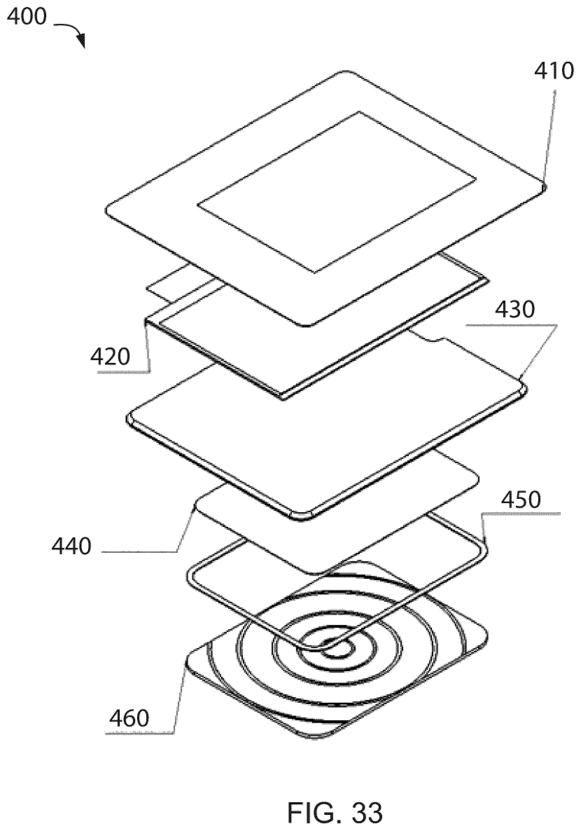

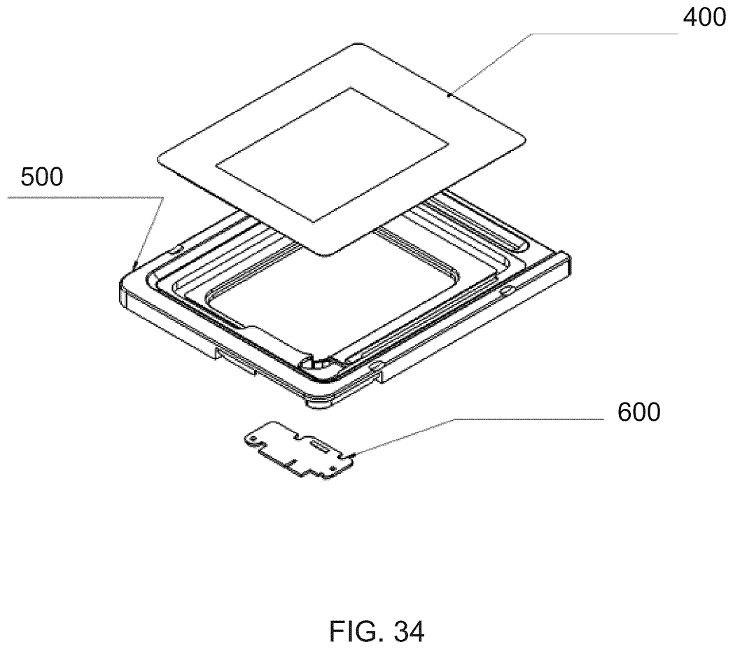

Turning now to the next figure, FIG. 33 illustrates an exploded view of a display assembly of an exemplary optical assembly system in accordance with the present invention. In some exemplary embodiments, as illustrated by FIG. 33, the display assembly 400 may include a filter 440 and a display panel 420, and may be adapted to modify how UV light from a light source interacts with the printing process. In some exemplary embodiments, a filter 440 may be situated below the display panel 420. In some exemplary embodiments, the display panel 420 is an LCD panel, wherein the LCD panel is situated above the filter. In some exemplary embodiments, the display assembly 400 is the light-diffusing element. In some exemplary embodiments, the display panel 420 may be an LCD panel. In some exemplary embodiments, the LCD panel may be transparent. In some exemplary embodiments, the filter 440 may be a light-diffusing film.

In some exemplary embodiments, the optical assembly system may be comprised of a display assembly 400 and a support structure or structural frame 500, wherein the display assembly 400 may include a protective glass 410, an LCD panel, a structural glass 430, a light-diffusing medium or filter 440, securing mechanism 450 and at least one lens 450. In some exemplary embodiments, the light-diffusing medium or filter 440 may be a light-diffusing film adapted to facilitate the uniform distribution of UV light and elimination of contrast inconsistencies during the curing process. In some exemplary embodiments, the optical assembly system further comprises a light source and a connection PCB. In some exemplary systems, the display assembly 400 may include a light source. In some exemplary embodiments, the at least one lens 460 may be a Fresnel lens. In some exemplary embodiments, the securing mechanism 450 may be a mounting tape or some other adhesive.

In some exemplary embodiments, the filter or light-diffusing medium 440 may be a light-diffusing film, wherein the light-diffusing film may be a polyethylene terephthalate (PET) film with a single-sided matte surface finish. In some exemplary embodiments, the optical assembly system may be adapted to achieve a light transmittance of 92%-95% and a haze of 94.7%-95.9%. In some exemplary embodiments, the PET film may be positioned such that the matte-finished surface of said PET film faces the light source, thereby achieving a light transmittance of 92%-96%. In some exemplary embodiments, the PET film of an exemplary optical polish LCD assembly system may have a thickness of 0.1 mm and a haze of 94.7%-95.9%.

In some exemplary embodiments, as illustrated in FIG. 33, the display assembly 400 may include a protective glass 410, an LCD panel 420, a structural glass 430, a diffusion film 440, a mounting tape 450, and a Fresnel lens 460. In some exemplary embodiments, as illustrated in FIG. 33, the diffusion film 440 is situated below the LCD panel 420.

In some exemplary embodiments, an additive manufacturing system in accordance with the present invention may be comprised of a reservoir for housing a photosensitive resin, a build surface, a light emitting system, and a light-diffusing element, wherein the light-diffusing element includes a separation assembly and a display assembly. In some exemplary embodiments, an additive manufacturing system in accordance with the present invention may be comprised of a reservoir for housing a photosensitive resin, a build surface, a light emitting system, and an optical assembly system.

In some exemplary embodiments, as illustrated in FIG. 33, the diffusion film of a display assembly 400 may be disposed between a lens and a structural glass 430, wherein the diffusion film may be situated directly below the structural glass 430 and above the lens. In some exemplary embodiments, the lens is a Fresnel lens.

In some exemplary embodiments, an optical assembly system in accordance with the present invention may include multiple functional layers arranged sequentially. For example, and in no way limiting the scope of the present invention, in some exemplary embodiments, a light engine may be situated at the base, followed by at least one lens 460, a filter or light diffusing medium 440, a structural glass 430, a display panel 420, and a protective glass 410 at top. In some exemplary embodiments, a light source may be situated at the base, followed by a Fresnel lens, a light-diffusing medium (e.g., a diffusion film), a structural glass, and LCD panel, and a protective glass at the top. In some exemplary embodiments, when the light from the light source passes through an exemplary display assembly or light-diffusing assembly 400, the light-diffusing medium 440 may be adapted to create a controlled scattering effect that significantly improves light uniformity across the entire printing area while effectively blurring harsh contours and surface outlines that would otherwise transfer to the 3D-printed object.

Turning now to the next figure, FIG. 34 illustrates an exploded view of an optical assembly system. In some exemplary embodiments, as illustrated in FIG. 34, an optical assembly system may include a display assembly 400, a support structure 500, and a connection PCB 600. In some exemplary embodiments, the support structure 500 may be a structural frame. In some exemplary embodiments, the support structure 500 may be a rigid substrate. In some exemplary embodiments, the display assembly 400 may be a light-diffusing assembly.

In some exemplary embodiments, the light-diffusing medium 440 may be a diffusion film as illustrated in FIG. 33. In other exemplary embodiments, the light-diffusing medium may be implemented in other approaches that are not limited to films alone. For example, and in no way limiting the scope of the invention, the light-diffusing medium may be implemented through specialized coatings applied directly to a structural glass 430 of a display assembly of an exemplary optical assembly system in accordance with the present invention. In yet another example, and in no way limiting the scope of the present invention, the light-diffusing medium may be implemented through embedded particles or structures within the glass itself. In yet another example, and in no way limiting the scope of the present invention, the light-diffusing medium may be implemented through micro-etched surfaces on any transparent component.

Moreover, the method of incorporating a light-diffusing medium is not restricted to a specific technique. In some exemplary embodiments, the light-diffusing medium may be mechanically sandwiched between components. In some embodiments, the light-diffusing medium may be adhered using optical-grade adhesives or tapes. In yet another exemplary embodiment, the light-diffusing medium may be directly laminated onto adjacent surfaces. In some exemplary embodiments, the light-diffusing medium may be chemically bonded through specialized processes. In other exemplary embodiments, the light-diffusing medium may be integrated during the manufacturing of the structural components themselves.

By deliberately introducing controlled light scattering in the optical path, an exemplary optical polish LCD assembly system may be adapted to eliminate the high-contrast edges and layer lines that typically require post-processing and may be further adapted to print 3D-objects with an optically polished appearance directly from the printer, dramatically reducing or eliminating manual finishing steps while enhancing transparency and surface quality.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware, or any combination thereof.

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. An additive manufacturing system comprising:
a reservoir for housing a photosensitive resin;
a build surface disposed within the reservoir;
a light emitting system; and
a light-diffusing element comprising:
a separation film including a separation film upper surface and a separation film lower surface;
a display assembly including a display panel and a diffusing film; and
a rigid substrate including a rigid substrate upper surface and a rigid substrate lower surface;
wherein a light emitted from the light emitting system is adapted to pass through the light-diffusing element structure to cure a layer of resin of a 3D-printed object.

2. The additive manufacturing system of claim 1, wherein the diffusing film includes a diffusing upper surface and a diffusing film lower surface.

3. The additive manufacturing system of claim 2, wherein the light-diffusing element further includes a first interface formed at a first mating of the separation film lower surface and the diffusing film upper surface, and a second interface formed at a second mating of the diffusing film lower surface and the rigid substrate upper surface;
wherein light emitted from the light emitting system passes through the rigid substrate and the second interface and through the diffusing film and the first interface and through the separation film to cure a layer of resin at a print surface; and
wherein the light is diffused by passing through the first interface and through the second interface.

4. The additive manufacturing system of claim 1, wherein:
the separation film upper surface includes a matte surface finish, and the separation film lower surface includes a glossy surface finish;
the diffusing film upper surface includes a glossy surface finish, and the diffusing film lower surface includes a matte surface finish; and
the rigid substrate upper surface includes an etched surface finish.

5. The additive manufacturing system of claim 1 wherein:
the separation film upper surface includes a matte surface finish, and the separation film lower surface includes a glossy surface finish;
the diffusing film upper surface includes a matte surface finish, and the diffusing film lower surface includes a glossy surface finish; and
the rigid substrate upper surface includes an etched surface finish.

6. The additive manufacturing system of claim 1 wherein:
the separation film upper surface includes a matte surface finish, and the separation film lower surface includes a glossy surface finish;
the diffusing film upper surface includes a glossy surface finish, and the diffusing film lower surface includes a matte surface finish; and
the rigid substrate upper surface includes a glossy surface finish.

7. The additive manufacturing system of claim 1 wherein:
the separation film upper surface includes a matte surface finish, and the separation film lower surface includes a glossy surface finish;
the diffusing film upper surface includes a matte surface finish, and the diffusing film lower surface includes a glossy surface finish; and
the rigid substrate upper surface includes a glossy surface finish.

8. The additive manufacturing system of claim 1 wherein:
the separation film comprises a transparent Polymethylpentene (PMP) film, and the separation film upper surface includes a glossy surface finish, and the separation film lower surface includes a matte surface finish;
the diffusing film comprises tempered glass, and the diffusing film upper surface includes a glossy surface finish, and the diffusing film lower surface includes a glossy surface finish; and
the rigid substrate upper surface includes an etched surface finish.

9. The additive manufacturing system of claim 1, wherein the diffusing film is a polyethylene terephthalate (PET) film with a thickness of 0.1 mm, a haze of 94.7%-95.9%, and a light transmittance of 92%-96%.

10. The additive manufacturing system of claim 1, wherein the diffusing film has a single-sided matte finished surface.

11. A method of using a three-dimensional (3D) printing system to form a transparent object, the method comprising:
receiving a digital model of the object, the digital model including at least one side surface;
offsetting a first at least one side surface to a first offset angle away from a vertical orientation to form a first offset side surface in the digital model;
determining a first side surface profile of the first offset side surface, wherein the first side surface profile includes a series of sequential transition steps with each transition step within the series of sequential transition steps including a vertical step size and a horizontal step size;
determining a single light pixel width used by the 3D printing system;
determining a proportion of the horizontal step size to the single light pixel width;
determining whether the proportion is within a proportion range;
in response to a determination that the proportion is within the proportion range, then:
3D printing the first side surface with the digital model at the first offset angle;
wherein the proportion range is one eighth to seven eighths.

12. The method of claim 11 wherein the proportion range is one quarter to three quarters.

13. The method of claim 11 wherein the proportion range is three eighths to five eighths.

14. The method of claim 11 wherein the proportion range is three eighths to one half.

15. The method of claim 11 wherein the first offset angle is about 1° to about 40°.

16. The method of claim 11 wherein the first offset angle is about 1° to about 30°.

17. The method of claim 11 wherein the first offset angle is about 1° to about 20°.

18. The method of claim 11 wherein the first offset angle is about 5° to about 15°.

19. The method of claim 11 wherein the first offset angle is about 10°.

20. The method of claim 11 further comprising:
prior to offsetting the first at least one side surface to the first offset angle away from a vertical orientation to form the first offset side surface in the model, orienting the first side surface of the digital model to the vertical orientation.
